(19) United States
(12) Patent Application Publication
(10) Pub. No.: US 2011/0237449 A1
(43) Pub. Date: Sep. 29, 2011

(54) Methods and Compositions for Nucleic Acid Purification

(75) Inventors: Gary K. McMaster, Ann Arbor, MI (US); Quan N. Nguyen, San Ramon, CA (US); Franklin R. Witney, Oakland, CA (US); Yunqing Ma, San Jose, CA (US)

(73) Assignee: AFFYMETRIX, INC., Santa Clara, CA (US)

(21) Appl. No.: 12/986,545

(22) Filed: Jan. 7, 2011

Related U.S. Application Data
(60) Provisional application No. 61/292,953, filed on Jan. 7, 2010.

(51) Int. Cl. C40B 30/04; C40B 40/06

(52) U.S. Cl. 506/9; 506/16

(57) ABSTRACT

Methods of capturing two or more nucleic acids simultaneously from a single sample are provided. Different nucleic acids are captured through cooperative hybridization events on a substrate, or different subsets of particles, or at different selected positions on a spatially addressable solid support. Methods described include enrichment and purification of nucleic acids prior to downstream steps including sequencing of target nucleic acids. Compositions, kits, and systems related to the methods are also described.

### FIELD OF THE INVENTION

The present invention is in the field of nucleic acid hybridization. The invention includes methods for capturing two or more nucleic acids simultaneously from a single sample. The invention also includes compositions and kits related to the methods.

### BACKGROUND OF THE INVENTION

A variety of techniques for detection and determination of the sequence of nucleic acids involve capture of the nucleic acids to a surface through hybridization of each nucleic acid to an oligonucleotide (or other nucleic acid) that is attached to the surface. For example, DNA microarray technology, which is widely used to analyze gene expression, relies on hybridization of DNA targets to preformed arrays of polynucleotides. (See, e.g., Lockhart and Winzeler (2000), “Genomics, gene expression and DNA arrays,” Nature, 405:827-36, Gerhold et al. (2001), “Monitoring expression of genes involved in drug metabolism and toxicology using DNA microarrays,” Physiol. Genomics, 5:161-70, Thomas et al. (2001), “Identification of toxicologically predictive gene sets using cDNA microarrays,” Mol. Pharmacol., 60:1189-94, and Epstein and Butow (2000), “Microarray technology—enhanced versatility, persistent challenge,” Curr. Opin. Biotechnol., 11:36-41).

A typical DNA microarray contains a large number of spots, with each spot containing a single oligonucleotide intended to hybridize to a particular nucleic acid target. For example, the GeneChip® microarray available from Affymetrix, Inc. (Santa Clara, Calif.) includes thousands of spots, with each spot containing a different single 25mer oligonucleotide. Multiple (e.g., about 20) oligonucleotides that are perfect matches for a particular target nucleic acid are typically provided, with each oligonucleotide being complementary to a different region of the target nucleic acid. Additional spots including mismatch oligonucleotides having a single nucleotide substitution in the middle of the oligonucleotide are also included in the array. Since binding to a single 25mer may not result in specific capture of the target nucleic acid, statistical methods are used to compare the signals obtained from all the spots for a particular target nucleic acid (e.g., perfectly matched and mismatched oligonucleotides) to attempt to correct for cross-hybridization of other nucleic acids to those spots.

In another approach, longer probes are used to form the spots in the microarray. For example, instead of short oligonucleotides, longer oligonucleotides or cDNAs can be used to capture the target nucleic acids. Use of such longer probes can provide increased specificity, but it can also make discrimination of closely related sequences difficult.

Recent advances in nucleic acid sequencing have been widely publicized. Often mentioned in the popular press are instances of whole genome sequencing provided directly to the consumer for mass market appeal. New companies are developing even newer “next generation” sequencing technologies designed to provide consumers with the entire sequence of their genome at a reasonable cost and within a reasonable amount of time. Companies like 23 and Me offer personalized genome analysis to individuals coupled with access to the genetic information through the internet. Customers can even share the genetic information supplied by the company with friends and families through popular social media networking sites. Using Single Molecule Real Time (SMRT) biology techniques, Pacific Biosciences has reported being able to sequence 12 million bases of DNA per hour, about one-third of a percent of a human genome. Roche Applied Sciences and Illumina have developed separate high-throughput DNA sequencing techniques that allow sequencing of an entire human genome for less than 100,000 USD. Helicos Biosciences has achieved the mapping of an entire human genome in one week for under 50,000 USD. In contrast, the Human Genome Project, begun in 1990, took 13 years and cost nearly $300 million to accomplish roughly the same sequencing.

The increased demand in the medical industry for genetic information motivates the continued development and implementation of new sequencing techniques. However, lacking in all of these innovations are suitable “front-end” methods for isolating complex subsets of genetic material at a scale required for these new techniques and technologies. (See, Porreca et al., “Multiplex amplification of large sets of human exons,” Nature Methods, 4:931-936, 2007). At the beginning of most new sequencing techniques is the need for genetic material. This material must be obtained from the subject whose genome is to be sequenced. Isolating, purifying, amplifying and otherwise capturing this genetic material upstream of the entire sequencing process is of critical importance, and in some degree, a major stumbling block to allowing these new sequencing techniques to be practically applied in the medical and/or healthcare industry.

Improved methods for capturing genetic material, target nucleic acids, are thus desirable. Among other aspects, the present invention provides methods that overcome the above noted limitations and permit rapid, simple, and highly specific capture of multiple nucleic acids simultaneously. The application provides methods and materials needed to enrich genetic samples for the target material to be sequenced. A complete understanding of the invention will be obtained upon review of the following.

### SUMMARY OF THE INVENTION

In one aspect, the present invention provides methods of capturing two or more nucleic acids of interest. Different nucleic acids are captured through cooperative hybridization events on different subsets of particles, or at different selected positions on a spatially addressable solid support, or at different positions within a well or other solid support. Compositions and kits related to the methods are also provided.

A first general class of embodiments provides methods of capturing two or more nucleic acids of interest. In the methods, a sample, and two or more subsets of n target capture probes, wherein n is at least two, are provided. The sample comprises or is suspected of comprising the nucleic acids of interest. Each subset of n target capture probes is capable of hybridizing to one of the nucleic acids of interest, and the target capture probes in each subset are also capable of hybridizing to one or more support capture probes, thereby associating each subset of n target capture probes with the substrate since support capture probes are bound to a substrate. In one class of embodiments, the substrate is a set of particles. In this class of embodiments, a plurality of the particles in each subset is distinguishable from a plurality of the particles in every other subset. Each nucleic acid of interest can thus, by hybridizing to its corresponding subset of n target capture probes which are in turn hybridized to a corresponding support capture probe, be associated with an identifiable subset of the particles.

When the sample and the subsets of n target capture probes are contacted, any nucleic acid of interest present in the sample, which is complementary to the target capture probe, is hybridized to its corresponding subset of n target capture probes, and the subset of n target capture probes is hybridized to its corresponding support capture probe. The hybridization of the nucleic acid of interest to the n target capture probes and the hybridization of the n target capture probes to the corresponding support capture probes captures the target nucleic acid on the substrate or subset of particles with which the target capture probes are associated. The hybridizing of the subset of n target capture probes to the corresponding support capture probe is performed at a hybridization temperature which is greater than a melting temperature Tₘ of a complex between each individual target capture probe and its corresponding support capture probe.

The methods are useful for multiplex capture of nucleic acids, optionally highly multiplex capture. Thus, the two or more nucleic acids of interest (i.e., the nucleic acids to be captured) optionally comprise five or more, 10 or more, 20 or more, 30 or more, 40 or more, 50 or more, or even 100 or more nucleic acids of interest. A like number of subsets of target capture probes are typically provided. In embodiments using particles, the two or more subsets of particles likewise can comprise five or more, 10 or more, 20 or more, 30 or more, 40 or more, 50 or more, or even 100 or more subsets of particles, while the two or more subsets of n target capture probes can comprise five or more, 10 or more, 20 or more, 30 or more, 40 or more, 50 or more, or even 100 or more subsets of n target capture probes.

In one class of embodiments, the particles are microspheres. The microspheres of each subset can be distinguishable from those of the other subsets, e.g., on the basis of their fluorescent emission spectrum, their diameter, or a combination thereof. In another class of embodiments, the particles are microparticles, or coded microparticles. (See, for instance, U.S. Patent Application Publication Nos. 2009/0149340, 2008/0038559 and 2007/0148599).

As noted, each of the two or more subsets of target capture probes includes n target capture probes, where n is at least two. However, n may be at least three, and n can be at least four or at least five or more. Typically, but not necessarily, n is at most ten. The n target capture probes in a subset may hybridize to nonoverlapping polynucleotide sequences in the corresponding nucleic acid of interest.

Each target capture probe is capable of hybridizing to a corresponding support capture probe. The target capture probe typically includes a polynucleotide sequence U-1 that is complementary to a polynucleotide sequence U-2 in its corresponding support capture probe. In one aspect, U-1 and U-2 are 20 nucleotides or less in length. In one class of embodiments, U-1 and U-2 are between 9 and 17 nucleotides in length (inclusive), preferably between 12 and 15 nucleotides (inclusive). In one embodiment, U1 and U2 are universal sequences which are the same in all capture probes and in all support capture probes.

As noted, the hybridizing the subset of n target capture probes to the corresponding support capture probe is performed at a hybridization temperature which is greater than a melting temperature Tₘ of a complex between each individual target capture probe and its corresponding support capture probe. The hybridization temperature is typically about 5° C. or more greater than the Tₘ, e.g., about 7° C. or more, about 10° C. or more, about 12° C. or more, about 15° C. or more, about 17° C. or more, or even about 20° C. or more greater than the Tₘ.

In one class of embodiments, contacting the sample, a pooled population of particles, and the subsets of n target capture probes comprises combining the sample with the subsets of n target capture probes to form a mixture, and then combining the mixture with the pooled population of particles. In this class of embodiments, the target capture probes typically hybridize first to the corresponding nucleic acid of interest and then to the corresponding particle-associated support capture probe. The hybridizations can, however, occur simultaneously or even in the opposite order. Thus, in another exemplary class of embodiments, contacting the sample, the pooled population of particles, and the subsets of n target capture probes comprises combining the sample, the subsets of target capture probes, and the pooled population of particles.

The target nucleic acids are optionally detected, amplified, isolated, sequenced and/or the like after capture. Thus, in one aspect, a plurality of the particles in each subset are distinguishable from a plurality of the particles in every other subset, and the methods include determining which subsets of particles have a nucleic acid of interest captured on the particles, thereby indicating which of the nucleic acids of interest were present in the sample. For example, in one class of embodiments, each of the nucleic acids of interest comprises a label (e.g., a fluorescent label), and determining which subsets of particles have a nucleic acid of interest captured on the particles comprises detecting a signal from the label. The methods can optionally be used to quantitate the amounts of the nucleic acids of interest present in the sample. For example, in one class of embodiments, an intensity of the signal from the label is measured, e.g., for each subset of particles, and correlated with a quantity of the corresponding nucleic acid of interest present. As another example, in one class of embodiments, determining which subsets of particles have a nucleic acid of interest captured on the particles comprises amplifying any nucleic acid of interest captured on the particles.

In one class of embodiments, one or more subsets of particles is isolated, whereby any nucleic acid of interest captured on the particles is isolated. The isolated nucleic acid can optionally be removed from the particles and/or subjected to further manipulation, if desired.

At any of various steps, materials not captured on the particles are optionally separated from the particles. For example, after the target capture probes, nucleic acids, and particle-bound support capture probes are hybridized, the particles are optionally washed to remove unbound nucleic acids and target capture probes.

The methods can be used to capture the nucleic acids of interest from essentially any type of sample. For example, the sample can be derived from an animal, a human, a plant, a cultured cell, a virus, a bacterium, a pathogen, and/or a microorganism. The sample optionally includes a cell lysate, an intercellular fluid, a bodily fluid (including, but not limited to, blood, serum, saliva, urine, sputum, or spinal fluid), and/or a conditioned culture medium, and is optionally derived from a tissue (e.g., a tissue homogenate), a biopsy, and/or a tumor. Similarly, the nucleic acids can be essentially any desired nucleic acids. As just a few examples, the nucleic acids of interest can be derived from one or more of an animal, a human, a plant, a cultured cell, a microorganism, a virus, a bacterium, insect, or a pathogen. As additional examples, the two or more nucleic acids of interest can comprise two or more mRNAs, bacterial and/or viral genomic RNAs and/or DNAs (double-stranded or single-stranded), plasmid or other extra-genomic DNAs, or other nucleic acids derived from microorganisms (pathogenic or otherwise).

Due to cooperative hybridization of multiple target capture probes to a nucleic acid of interest, for example, even nucleic acids present at low concentration can be captured. Thus, in one class of embodiments, at least one of the nucleic acids of interest is present in the sample in a non-zero amount of 200 amol or less, 150 amol or less, 100 amol or less, 50 amol or less, 10 amol or less, 1 amol or less, or even 0.1 amol or less.

Capture of a particular nucleic acid is optionally quantitative. Thus, in one exemplary class of embodiments, the sample includes a first nucleic acid of interest, and at least 30%, at least 50%, at least 80%, at least 90%, at least 95%, or even at least 99% of a total amount of the first nucleic acid present in the sample is captured on a first subset of particles. Such quantitative capture can occur without capture of a significant amount of undesired nucleic acids, even those of very similar sequence to the nucleic acid of interest. Thus, in one class of embodiments, the sample comprises or is suspected of comprising a first nucleic acid of interest and a second nucleic acid which has a polynucleotide sequence which is 95% or more identical to that of the first nucleic acid (e.g., 96% or more, 97% or more, 98% or more, or even 99% or more identical). The first nucleic acid, if present in the sample, is captured on a first subset of particles, while the second nucleic acid comprises 1% or less of a total amount of nucleic acid captured on the first subset of particles (e.g., 0.5% or less, 0.2% or less, or even 0.1% or less).

In one class of embodiments, the sample comprises a first nucleic acid of interest and a second nucleic acid, where the first nucleic acid is a first splice variant and the second nucleic acid is a second splice variant of the given mRNA. A first subset of n target capture probes is capable of hybridizing to the first splice variant, of which at most n−1 target capture probes are capable of hybridizing to the second splice variant. Preferably, hybridization of the n target capture probes to the first splice variant captures the first splice variant on a first subset of particles while hybridization of the at most n−1 target capture probes to the second splice variant does not capture the second splice variant on the first subset of particles.

Another general class of embodiments provides a composition that includes two or more subsets of particles and two or more subsets of n target capture probes, wherein n is at least two. The particles in each subset have associated therewith a different support capture probe. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. When the nucleic acid of interest corresponding to a subset of n target capture probes is present in the composition and is hybridized to the subset of n target capture probes, which are hybridized to the corresponding support capture probe, the nucleic acid of interest is hybridized to the subset of n target capture probes at a hybridization temperature which is greater than a melting temperature Tₘ of a complex between each individual target capture probe and the support capture probe. In one class of embodiments, a plurality of the particles in each subset are distinguishable from a plurality of the particles in every other subset.

The composition optionally includes a sample comprising or suspected of comprising at least one of the nucleic acids of interest. In one class of embodiments, the composition is maintained at the hybridization temperature and comprises one or more of the nucleic acids of interest; each nucleic acid of interest is hybridized to its corresponding subset of n target capture probes, the corresponding subset of n target capture probes being hybridized to its corresponding support capture probe.

Essentially all of the features noted for the methods above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

A related general class of embodiments provides a composition comprising two or more subsets of particles, two or more subsets of n target capture probes, wherein n is at least two, and at least a first nucleic acid of interest. The particles in each subset have associated therewith a different support capture probe. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. In this class of embodiments, the composition is maintained at a hybridization temperature, which hybridization temperature is greater than a melting temperature Tₘ of a complex between each individual target capture probe and its corresponding support capture probe. The first nucleic acid of interest is hybridized to a first subset of n first target capture probes, which first target capture probes are hybridized to a first support capture probe. In one class of embodiments, a plurality of the particles in each subset are distinguishable from a plurality of the particles in every other subset.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Yet another general class of embodiments provides a kit for capturing two or more nucleic acids of interest. The kit includes two or more subsets of particles and two or more subsets of n target capture probes, wherein n is at least two, packaged in one or more containers. The particles in each subset have associated therewith a different support capture probe. Alternatively, the kit may contain support capture probes without particles. The support capture probes may then be bound to any substrate of interest to the end user and/or a support may be supplied in the kit. For instance, the support capture probes may be present in the kit already bound to a substrate, such as to the bottom of a well in a 96-well plate, or any plate of any number of wells. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. When the nucleic acid of interest corresponding to a subset of n target capture probes is hybridized to the subset of n target capture probes, which are hybridized to the corresponding support capture probe, the nucleic acid of interest is hybridized to the subset of n target capture probes at a hybridization temperature which is greater than a melting temperature Tₘ of a complex between each individual target capture probe and the support capture probe. The kit optionally also includes instructions for using the kit to capture and optionally detect the nucleic acids of interest, one or more buffered solutions (e.g., lysis buffer, diluent, hybridization buffer, and/or wash buffer), standards comprising one or more nucleic acids at known concentration, and/or the like. In one class of embodiments, a plurality of the particles in each subset are distinguishable from a plurality of the particles in every other subset.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Another general class of embodiments includes methods of capturing two or more nucleic acids of interest. In the methods, a sample, a solid support, and two or more subsets of n target capture probes, wherein n is at least two, are provided. The sample comprises or is suspected of comprising the nucleic acids of interest. The solid support comprises two or more support capture probes, each of which is provided at a selected position on the solid support. Each subset of n target capture probes is capable of hybridizing to one of the nucleic acids of interest, and the target capture probes in each subset are capable of hybridizing to one of the support capture probes and thereby associating each subset of n target capture probes with a selected position on the solid support. Each nucleic acid of interest can thus, by hybridizing to its corresponding subset of n target capture probes which are in turn hybridized to a corresponding support capture probe, be associated with, e.g., a known, predetermined location on the solid support. The sample, the solid support, and the subsets of n target capture probes are contacted, any nucleic acid of interest present in the sample is hybridized to its corresponding subset of n target capture probes, and the subset of n target capture probes is hybridized to its corresponding support capture probe. The hybridizing the nucleic acid of interest to the n target capture probes and the n target capture probes to the corresponding support capture probe captures the nucleic acid on the solid support at the selected position with which the target capture probes are associated.

Hybridizing the subset of n target capture probes to the corresponding support capture probe is optionally performed at a hybridization temperature which is greater than a melting temperature Tₘ of a complex between each individual target capture probe and its corresponding support capture probe.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Yet another general class of embodiments provides a composition that includes a solid support comprising two or more support capture probes, each of which is provided at a selected position on the solid support, and two or more subsets of n target capture probes, wherein n is at least two. Each subset of n target capture probes is capable of hybridizing to one of the nucleic acids of interest, and the target capture probes in each subset are capable of hybridizing to one of the support capture probes and thereby associating each subset of n target capture probes with a selected position on the solid support.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Another general class of embodiments provides a kit for capturing two or more nucleic acids of interest. The kit includes a solid support comprising two or more support capture probes, each of which is provided at a selected position on the solid support, and two or more subsets of n target capture probes, wherein n is at least two, packaged in one or more containers. Each subset of n target capture probes is capable of hybridizing to one of the nucleic acids of interest, and the target capture probes in each subset are capable of hybridizing to one of the support capture probes and thereby associating each subset of n target capture probes with a selected position on the solid support.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

In another embodiment of the present invention, the target nucleic acid of interest may be about 10 kilobases (kB) in length, 1.7 kB, 3 kB, or longer. Alternatively, the target nucleic acid may be any number of kB in length between 10-40 kB, or even 45 kB or 50 kB in length or more. The target nucleic acid of interest may be as long as 100 kB in length. In this embodiment, the target capture probes may be designed such that they bind to regions within the target nucleic acid. The regions that the target capture probes are complementary to the target nucleic acid may be separated by an insubstantial or a significant length of nucleic acid sequence which may be of known or unknown length. As a non-limiting example of such an embodiment, two or more target capture probes may have sequences complementary to a 40 kB length target nucleic acid. The two or more target capture probes may be complementary to this target nucleic acid both on the very 5′ end and at the very 3′ end, with as many as 39.5 kB or more nucleic acid between the two or more target capture probe hybridization locations. Target capture probes may be designed to hybridized to the target nucleic acid at any position along the entire length of the target nucleic acid.

In some embodiments, the method of the presently claimed invention is designed to determine the sequence of the target nucleic acid that lies between the two ends of the target nucleic acid that are hybridized to by the target capture probes. Thus, there may be a first set of one or more target capture probes hybridized at the very 5′ end of the target nucleic acid, and a second set of one or more target capture probes hybridized at the very 3′ end of the target nucleic acid, or any location therebetween.

In the above embodiments, the method may further include hybridization of random primers to the target nucleic acid after, or simultaneously with, the hybridization of the target nucleic acid to the target capture probes and/or support capture probes. The random primers then bind to the regions of the target nucleic acid where target capture probes are not bound. (See, for instance, Wong et al., Nucl. Acids Res., 24:3778-3783, 1996, incorporated herein by reference). For instance, in the above class of non-limiting embodiments, where there is a significant stretch of unknown sequence in the target nucleic acid between the two sets of target capture probes, the random primers could hybridize thereto to create randomly positioned double-stranded (ds) regions of target nucleic acid. The random primers may be of any suitable length. For instance, random primers are known to be useful in hexamer length, 7-mer length, 8-mer length, and the like.

Upon hybridization of the random primers to the target nucleic acid, polymerase enzymes may be used to generate a complete double-stranded copy of the target nucleic acid corresponding to the regions where the random primers hybridized. Polymerase enzymes are known in the art which possess strand displacement activity, and others which do not possess strand displacement activity. Non-strand-displacing polymerases, used in this embodiment, would leave various “nicks” in the double-stranded target nucleic acid.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

In the above described exemplary embodiment, the long stretches of target nucleic acid which has been converted to double-stranded nucleic acid may be further broken into smaller fragments of double-stranded nucleic acid. For instance, by sonication, nuclease treatment, DNase I treatment, restriction enzyme exposure, such as HaeIII, or other enzymatic and non-enzymatic methods, the double-stranded target nucleic acid may be broke into smaller segments having a length of, for instance 50 base pairs (bp) or more. (See, for instance, Elsner et al., “Ultrasonic Degradation of DNA,” DNA, 8(10):697-701, 1989). Alternatively, the double-stranded target nucleic acids may be broken down into 50-60 bp lengths, or 50-60 bp lengths, or 60-70 bp lengths, or 70-100 bp lengths, or 100-200 bp lengths, or 200-300 bp lengths, or 300-400 bp lengths, or 400-500 bp lengths, or any mixture of lengths lying between these ranges, such that the target double-stranded nucleic acid may be directly used in later nucleic acid sequencing methodologies.

In the above-described embodiment, the method may optionally further include ligation of asymmetric adapters by enzymes known to be capable of such ligation. Ligation may be performed on blunt-ended double-stranded target nucleic acid. Ligation may be performed using various known means, such as use of T4 DNA ligase, and the like. The target double-stranded nucleic acid may be additionally prepared prior to ligation by forming blunt ends, using any number of known procedures for such tasks, such as, for instance, the use of DNA polymerase I, (Klenow) fragment or T4 DNA polymerase, and the like. Furthermore, to prevent ligation of asymmetric adapters to non-target nucleic acids, e.g. probes, the probes may comprise modified ends, such as dideoxynucleotide and amide ends or o-methyl groups at the 3 prime and 5 prime ends to preclude ligation by T4 DNA ligase.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Various known sequencing methodologies may be employed using the generated purified target nucleic acids generated utilizing the above embodiments and methods. Furthermore, to prevent generation of target double-stranded nucleic acid sequences corresponding to known sequences located between target capture probe hybridization sites, blocking probes may be included in the reactions precluding formation of double-stranded target nucleic acid fragments corresponding to those regions.

In a further embodiment, the target capture probes, blocking probes, and/or support capture probes may be made of ribonucleic acid. In this class of embodiments, the probes may then be selectively degraded and thereby removed from later reactions by RNase or other known non-enzymatic means of selectively degrading RNA in a mixture of RNA and DNA. Conversely, if the target nucleic acid is RNA, for instance perhaps it may be mRNA, then the probes may alternatively be comprised of DNA and a selective agent applied to eliminate the DNA probes from the RNA targets capture and purified.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

In another embodiment of the above methods, the random primers may include therein adapters, such that later treatments to create blunt ends and ligate adapters are not necessary. Further, the random primers may not be random at all. That is, primers with or without adapter sequences may be designed for regions of the target nucleic acid for which sequence information is already known. Later creation of double-stranded DNA may then be started in the known regions and proceed to unknown regions. Further manipulations as described above can then be used to generate double-stranded target nucleic acids of desired length and possessing adapters for use in downstream sequencing methodologies.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Additionally, the invention discloses embodiments that do not require the generation of double-stranded target nucleic acid. Instead, single-stranded target nucleic acids are isolated from the sample using the present methods, and then optionally broken into single-stranded target nucleic acids of desired length and adapters ligated thereto. It is known that T4 RNA ligase, and other ligases, are capable of ligating small adapter sequences to single-stranded nucleic acids. (See, Zhang et al., Nuc. Acids Res., 1996, and Edwards et al. (1991) Nucleic Acids Res., 19:5227-5232, and Tessier et al., (1986) Anal. Biochem., 158, 171-178). Ligation of asymmetric adapters to the single stranded target nucleic acid may be achieved by utilizing adaptors which possess a 5 prime phosphate group. These single-stranded target nucleic acids, optionally possessing adapters, may also then be used in further downstream sequencing methodologies designed to determine the nucleic acid sequence of the target nucleic acid in the unknown regions lying between the target capture probe hybridization sites.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

### BRIEF DESCRIPTION OF THE DRAWINGS

FIG. 1, Panels A-D, schematically depicts multiplex capture and detection of nucleic acids, where the nucleic acids of interest are captured on distinguishable subsets of microspheres and then detected.

FIG. 2 schematically depicts an exemplary embodiment in which two splice variants are specifically captured on distinguishable subsets of microspheres.

FIG. 3, Panels A-C, schematically depict multiplex capture of nucleic acids, where the nucleic acids of interest are captured at selected positions on a solid support. Panel A shows a top view of the solid support, while Panels B-C show the support in cross-section.

FIG. 4, Panels A-B, schematically depict capture of a target nucleic acid by two classes of embodiments. Panel A depicts target capture probes aligned at one end of the target nucleic acid, whereas Panel B depicts target capture probes aligned in two sets at opposite ends of the target nucleic acid.

FIG. 5, Panels A-B schematically depict downstream steps in one embodiment method in which target nucleic acid is used as template to create double-stranded target nucleic acid (Panel A) using primers hybridizing throughout the target nucleic acid. Subsequent steps including cleaving of the double-stranded target nucleic acid into smaller nucleic acid sequences for downstream sequencing is depicted in Panel B.

FIG. 6, Panels A-B schematically represent steps following the embodiment depicted in prior Figures, especially incubation with asymmetrical adapters with ligase and the double-stranded target nucleic acids (Panel A) to yield double-stranded target nucleic acid with asymmetrical adapters (Panel B).

FIG. 7, Panels A-E schematically depicts capture, (Panel A), dissociation of captured probe after washing (Panel B), cleavage of the target nucleic acid into smaller nucleic acids (Panel C), addition of asymmetric adapters (Panel D), and ligation of the adapters (Panel E).

Schematic figures are not necessarily to scale.

### DEFINITIONS

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in the practice for testing of the present invention, the preferred materials and methods are described herein. Accordingly, the terminology used herein is for the purpose of describing particular embodiments only, and is not intended to be limiting.

As used in this specification and the appended claims, the singular forms “a,” “an” and “the” include plural referents unless the context clearly dictates otherwise. Thus, for example, reference to “a molecule” includes a plurality of such molecules, and the like.

The term “about” as used herein indicates the value of a given quantity varies by +/−10% of the value, or optionally +/−5% of the value, or in some embodiments, by +/−1% of the value so described.

Throughout this disclosure, various aspects of this invention can be presented in a range format. It should be understood that when a description is provided in range format, this is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, for example, as well as individual numbers within that range, for example, 1, 2, 3, 4, 5, and 6. This applies regardless of the breadth of the range.

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. (See, U.S. Pat. No. 5,744,305 for exemplary substrates).

The solid support may be biological, nonbiological, organic, inorganic, or a combination of any of these, existing as particles, strands, precipitates, gels, sheets, tubing, spheres, containers, capillaries, pads, slices, films, plates, slides, etc. The solid support is preferably flat but may take on alternative surface configurations. For example, the solid support may contain raised or depressed regions on which synthesis takes place. In some embodiments, the solid support will be chosen to provide appropriate light-absorbing characteristics. For example, the support may be a polymerized Langmuir Blodgett film, functionalized glass, Si, Ge, GaAs, GaP, SiO₂, SiN₄, modified silicon, or any one of a variety of gels or polymers such as (poly)tetrafluoroethylene, (poly)vinylidendifluoride, polystyrene, polycarbonate, or combinations thereof. Other suitable solid support materials will be readily apparent to those of skill in the art. Preferably, the surface of the solid support will contain reactive groups, which could be carboxyl, amino, hydroxyl, thiol, or the like. More preferably, the surface will be optically transparent and will have surface Si—H functionalities, such as are found on silica surfaces.

Attached to the solid support may be an optional spacer, L₁. The spacer molecules are preferably of sufficient length to permit the double-stranded oligonucleotides in the completed member of the library to interact freely with molecules exposed to the library. The spacer molecules, when present, are typically 6-50 atoms long to provide sufficient exposure for the attached double-stranded DNA molecule. The spacer, L₁, is comprised of a surface attaching portion and a longer chain portion. The surface attaching portion is that part of L₁ which is directly attached to the solid support. This portion can be attached to the solid support via carbon-carbon bonds using, for example, supports having (poly)trifluorochloroethylene surfaces, or preferably, by siloxane bonds (using, for example, glass or silicon oxide as the solid support). Siloxane bonds with the surface of the support are formed in one embodiment via reactions of surface attaching portions bearing trichlorosilyl or trialkoxysilyl groups. The surface attaching groups will also have a site for attachment of the longer chain portion. For example, groups which are suitable for attachment to a longer chain portion would include amines, hydroxyl, thiol, and carboxyl. Preferred surface attaching portions include aminoalkylsilanes and hydroxyalkylsilanes.

The term “polynucleotide” (and the equivalent term “nucleic acid”) encompasses any physical string of monomer units that can be corresponded to a string of nucleotides, including a polymer of nucleotides (e.g., a typical DNA or RNA polymer), peptide nucleic acids (PNAs), modified oligonucleotides (e.g., oligonucleotides comprising nucleotides that are not typical to biological RNA or DNA, such as 2′-O-methylated oligonucleotides, LNA, etc.), and the like. The nucleotides of the polynucleotide can be deoxyribonucleotides, ribonucleotides or nucleotide analogs, can be natural or non-natural, and can be unsubstituted, unmodified, substituted or modified. The nucleotides can be linked by phosphodiester bonds, or by phosphorothioate linkages, methylphosphonate linkages, boranophosphate linkages, or the like. The polynucleotide can optionally further comprise non-nucleotide elements such as labels, quenchers, blocking probes, or the like. The polynucleotide can be, e.g., single-stranded or double-stranded.

A “polynucleotide sequence” or “nucleotide sequence” is a polymer of nucleotides (an oligonucleotide, a DNA, a nucleic acid, etc.) or a character string representing a nucleotide polymer, depending on context. From any specified polynucleotide sequence, either the given nucleic acid or the complementary polynucleotide sequence (e.g., the complementary nucleic acid) can be determined.

Two polynucleotides “hybridize” when they associate to form a stable duplex, e.g., under relevant assay conditions. Nucleic acids hybridize due to a variety of well characterized physico-chemical forces, such as hydrogen bonding, solvent exclusion, base stacking and the like. An extensive guide to the hybridization of nucleic acids is found in Tijssen (1993) Laboratory Techniques in Biochemistry and Molecular Biology-Hybridization with Nucleic Acid Probes, part I chapter 2, “Overview of principles of hybridization and the strategy of nucleic acid probe assays” (Elsevier, New York), as well as in Ausubel, infra.

The “Tₘ” (melting temperature) of a nucleic acid duplex under specified conditions (e.g., relevant assay conditions) is the temperature at which half of the base pairs in a population of the duplex are disassociated and half are associated. The Tₘ for a particular duplex can be calculated and/or measured, e.g., by obtaining a thermal denaturation curve for the duplex (where the Tₘ is the temperature corresponding to the midpoint in the observed transition from double-stranded to single-stranded form).

The term “complementary” refers to a polynucleotide that forms a stable duplex with its “complement,” e.g., under relevant assay conditions. Typically, two polynucleotide sequences that are complementary to each other have mismatches at less than about 20% of the bases, at less than about 10% of the bases, preferably at less than about 5% of the bases, and more preferably have no mismatches.

A “target capture probe” is a polynucleotide that is capable of hybridizing to a nucleic acid of interest and to a support capture probe. The target capture probe typically has a first polynucleotide sequence U-1, which is complementary to the support capture probe, and a second polynucleotide sequence U-3, which is complementary to a polynucleotide sequence of the nucleic acid of interest, e.g. target nucleic acid. Sequences U-1 and U-3 are typically not complementary to each other. The target capture probe is preferably single-stranded. The target capture probe, as with all probes, may be DNA, RNA, or any nucleic acid analog, or may contain a percentage of nucleic acid analog, e.g. may be anywhere from 1% to 100% comprised of nucleic acid analog components.

A “support capture probe” is a polynucleotide that is capable of hybridizing to at least one target capture probe and that is tightly bound (e.g., covalently or noncovalently, directly or through a linker, e.g., streptavidin-biotin or the like) to a solid support, a spatially addressable solid support, a slide, a particle, a microsphere, or the like. The support capture probe typically comprises at least one polynucleotide sequence U-2 that is complementary to polynucleotide sequence U-1 of at least one target capture probe. The support capture probe is preferably single-stranded.

A “label” is a moiety that facilitates detection of a molecule. Common labels in the context of the present invention include fluorescent, luminescent, light-scattering, and/or colorimetric labels. Suitable labels include enzymes and fluorescent moieties, as well as radionuclides, substrates, cofactors, inhibitors, chemiluminescent moieties, magnetic particles, and the like. Patents teaching the use of such labels include U.S. Pat. Nos. 3,817,837; 3,850,752; 3,939,350; 3,996,345; 4,277,437; 4,275,149; and 4,366,241. Many labels are commercially available and can be used in the context of the invention.

A “microsphere” is a small spherical, or roughly spherical, particle. A microsphere typically has a diameter less than about 1000 micrometers (e.g., less than about 100 micrometers, optionally less than about 10 micrometers). A microsphere may be a microparticle, which may or may not comprise a barcode or other identifying feature. (See, for instance, U.S. Patent Application Publication Nos. 2009/0149340, 2008/0038559 and 2007/0148599). Microparticles may also be referred to simply as one or more particles or population of particles.

A “microorganism” is an organism of microscopic or submicroscopic size. Examples include, but are not limited to, bacteria, fungi, yeast, protozoans, microscopic algae (e.g., unicellular algae), viruses (which are typically included in this category although they are incapable of growth and reproduction outside of host cells), subviral agents, viroids, and mycoplasma.

A variety of additional terms are defined or otherwise characterized herein.

### DETAILED DESCRIPTION

The present invention provides methods, compositions, and kits for multiplex capture and enrichment or purification of nucleic acids. A particular nucleic acid of interest is captured to a surface through cooperative hybridization of multiple target capture probes to the nucleic acid. Each of the target capture probes has a first polynucleotide sequence that can hybridize to the target nucleic acid and a second polynucleotide sequence that can hybridize to a support capture probe that is bound to the surface. The temperature and the stability of the complex between a single target capture probe and its corresponding support capture probe can be controlled such that binding of a single target capture probe to a nucleic acid and to the support capture probe is not sufficient to stably capture the nucleic acid on the surface to which the support capture probe is bound, whereas simultaneous binding of two or more target capture probes to a single target nucleic acid molecule can capture the target nucleic acid onto the surface. Requiring such cooperative hybridization of multiple target capture probes for capture of each nucleic acid of interest results in high specificity and low background, which may be caused by cross-hybridization of the target capture probes with other, non-target, nucleic acids. Such low background and minimal cross-hybridization are typically substantially more difficult to achieve in multiplex than a single-plex capture of nucleic acids, because the number of potential nonspecific interactions are greatly increased in a multiplex experiment due to the increased number of probes used (e.g., the greater number of target capture probes). Requiring multiple simultaneous target capture probe-support capture probe interactions for the capture of a single target nucleic acid molecule minimizes the chance that nonspecific capture will occur, even under conditions in which some nonspecific target-target capture probe and/or target capture probe-support capture probe interactions may occur.

The methods of the invention can be used for multiplex capture of two or more nucleic acids simultaneously, for example, from even complex samples, without requiring prior purification of the nucleic acids, when the nucleic acids are present at low concentration, and/or in the presence of other, highly similar nucleic acids. In one aspect, the methods involve capture of the nucleic acids to particles (e.g., distinguishable subsets of microspheres), while in another aspect, the nucleic acids are captured to a spatially addressable solid support. In other aspects, the nucleic acids may be captured to a well, for instance to a plate with wells, e.g. a 96-well plate, or similar plate of any number of wells. After capture, the nucleic acids are optionally detected, amplified, isolated, and/or the like. Compositions, kits, and systems related to the methods are also provided.

### Methods

A first general class of embodiments includes methods of capturing two or more nucleic acids of interest. In the methods, a sample, a pooled population of particles, and two or more subsets of n target capture probes, wherein n is at least two, are provided. The sample comprises or is suspected of comprising the nucleic acids of interest. The pooled population of particles includes two or more subsets of particles. The particles in each subset have associated therewith a different support capture probe, e.g. each particle has attached thereto a plurality of support capture probes wherein each population of particles has associated therewith support capture probes all having the same unique U2 sequence. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. Preferably, a plurality of the particles in each subset are distinguishable from a plurality of the particles in every other subset. (Typically, substantially all of the particles in each subset are distinguishable from substantially all of the particles in every other subset.) Each nucleic acid of interest can thus, by hybridizing to its corresponding subset of n target capture probes which are in turn hybridized to a corresponding support capture probe, be associated with an identifiable subset of the particles. Alternatively, the particles in the various subsets need not be distinguishable from each other (for example, in embodiments in which any nucleic acid of interest present is to be isolated, amplified, enriched, purified, sequenced and/or detected, without regard to its identity, following its capture on the particles.)

When the sample, the pooled population of particles, and the subsets of n target capture probes are contacted, any nucleic acid of interest present in the sample is hybridized to its corresponding subset of n target capture probes, and the subset of n target capture probes is hybridized to its corresponding support capture probe. Hybridization of the nucleic acid of interest to the n target capture probes, and hybridization of the n target capture probes to the corresponding support capture probes, captures the nucleic acid on the subset of particles, or substrate, with which the target capture probes are associated, e.g. covalently bound to. Hybridization of the subset of n target capture probes to the corresponding support capture probe is performed at a hybridization temperature which is greater than a melting temperature Tₘ of a complex between each individual target capture probe and its corresponding support capture probe. Binding of a single target capture probe to its corresponding nucleic acid (or to an extraneous nucleic acid) and support capture probe is thus typically insufficient to capture the nucleic acid on the corresponding subset of particles. It will be evident that the hybridization temperature is typically less than a Tₘ of a complex between the nucleic acid of interest, all n corresponding target capture probes, and the corresponding support capture probe.

The methods are useful for multiplex capture of nucleic acids, optionally highly multiplex capture. Thus, the two or more nucleic acids of interest (i.e., the nucleic acids to be captured) optionally comprise five or more, 10 or more, 20 or more, 30 or more, 40 or more, 50 or more, or even 100 or more nucleic acids of interest. A like number of subsets of particles and subsets of target capture probes are typically provided; thus, the two or more subsets of particles can comprise five or more, 10 or more, 20 or more, 30 or more, 40 or more, 50 or more, or even 100 or more subsets of particles, while the two or more subsets of n target capture probes can comprise five or more, 10 or more, 20 or more, 30 or more, 40 or more, 50 or more, or even 100 or more subsets of n target capture probes.

Essentially any suitable particles, e.g., particles to which support capture probes can be attached and which optionally have distinguishable characteristics, can be used. For example, in one preferred class of embodiments, the particles are microspheres or microparticles, as described above. The microspheres of each subset can be distinguishable from those of the other subsets, e.g., on the basis of their fluorescent emission spectrum, barcode, their diameter, or a combination thereof. For example, the microspheres of each subset can be labeled with a unique fluorescent dye or mixture of such dyes, quantum dots with distinguishable emission spectra, and/or the like. As another example, the particles of each subset can be identified by an optical barcode, unique to that subset, present on or in the particles.

The particles optionally have additional desirable characteristics. For example, the particles can be magnetic or paramagnetic, which provides a convenient means for separating the particles from solution, e.g., to simplify separation of the particles from any materials not bound to the particles.

As noted, each of the two or more subsets of target capture probes includes n target capture probes, where n is at least two. Preferably, n is at least three, and n can be at least four or at least five or more. Typically, but not necessarily, n is at most ten. For example, n can be between three and ten, e.g., between five and ten or between five and seven, inclusive. Use of fewer target capture probes can be advantageous, for example, in embodiments in which nucleic acids of interest are to be specifically captured from samples including other nucleic acids with sequences very similar to that of the nucleic acids of interest. In other embodiments (e.g., embodiments in which capture of as much of the nucleic acid as possible is desired), however, n can be more than 10, e.g., between 20 and 50. n can be the same for all of the subsets of target capture probes, but it need not be; for example, one subset can include three target capture probes while another subset includes five target capture probes. The n target capture probes in a subset preferably hybridize to nonoverlapping polynucleotide sequences in the corresponding nucleic acid of interest. The nonoverlapping polynucleotide sequences can, but need not be, consecutive within the nucleic acid of interest. Alternatively, as mentioned above, the nonoverlapping sequences may be separated by a significantly longer sequence of nucleotides, such as, by as much as 10 kB, 20 kB, 30 kB, or 40 kB or more.

Each target capture probe is capable of hybridizing to its corresponding support capture probe. The target capture probe typically includes a polynucleotide sequence U-1 that is complementary to a polynucleotide sequence U-2 in its corresponding support capture probe. In one aspect, U-1 and U-2 are 20 nucleotides or less in length. In one class of embodiments, U-1 and U-2 are between 9 and 17 nucleotides in length (inclusive), preferably between 12 and 15 nucleotides (inclusive). For example, U-1 and U-2 can be 14, 15, 16, or 17 nucleotides in length, or they can be between 9 and 13 nucleotides in length (e.g., for lower hybridization temperatures, e.g., hybridization at room temperature).

The support capture probe can include polynucleotide sequence in addition to U-2, or U-2 can comprise the entire polynucleotide sequence of the support capture probe. For example, each support capture probe optionally may include a linker sequence between the site of attachment of the support capture probe to the particles and sequence U-2, e.g. a linker sequence containing 8 Ts, 8 Us, 8 Gs, 8 Cs, 8 As, or 8 of any nucleic acid analog such as an LNA, or alternatively 10 such nucleic acids, or 15 or 20 or more.

It will be evident that the amount of overlap between each individual target capture probe and its corresponding support capture probe (i.e., the length of U-1 and U-2) affects the Tₘ of the complex between that target capture probe and support capture probe, as does, e.g., the GC base content of sequences U-1 and U-2. Typically, all the support capture probes are the same length (as are sequences U-1 and U-2) from subset of particles to subset. However, depending, e.g., on the precise nucleotide sequence of U-2, different support capture probes optionally have different lengths and/or different length sequences U-2, to achieve the desired Tₘ. Different support capture probe-target capture probe complexes optionally have the same or different Tₘs.

It will also be evident that the number of target capture probes required for stable capture of a nucleic acid depends, in part, on the amount of overlap between the target capture probes and the support capture probe (i.e., the length of U-1 and U-2). For example, if n is 5-7 for a 14 nucleotide overlap, n could be 3-5 for a 15 nucleotide overlap or 2-3 for a 16 nucleotide overlap.

As noted, the hybridizing the subset of n target capture probes to the corresponding support capture probe is performed at a hybridization temperature which is greater than a melting temperature Tₘ of a complex between each individual target capture probe and its corresponding support capture probe. The hybridization temperature is typically about 5° C. or more greater than the Tₘ, e.g., about 7° C. or more, about 10° C. or more, about 12° C. or more, about 15° C. or more, about 17° C. or more, or even about 20° C. or more greater than the Tₘ.

Stable capture of nucleic acids of interest, e.g., while minimizing capture of extraneous nucleic acids (e.g., those to which n−1 or fewer of the target capture probes bind) can be achieved, for example, by balancing n (the number of target capture probes), the amount of overlap between the target capture probes and the support capture probe (the length of U-1 and U-2), and/or the stringency of the conditions under which the target capture probes, the nucleic acids, and the support capture probes are hybridized.

Appropriate combinations of n, amount of complementarity between the target capture probes and the support capture probe, and stringency of hybridization can, for example, be determined experimentally by one of skill in the art. For example, a particular value of n and a particular set of hybridization conditions can be selected, while the number of nucleotides of complementarity between the target capture probes and the support capture probe is varied until hybridization of the n target capture probes to a nucleic acid captures the nucleic acid while hybridization of a single target capture probe does not efficiently capture the nucleic acid. Similarly, n, amount of complementarity, and stringency of hybridization can be selected such that the desired nucleic acid of interest is captured while other nucleic acids present in the sample are not efficiently captured. Stringency can be controlled, for example, by controlling the formamide concentration, chaotropic salt concentration, salt concentration, pH, organic solvent content, and/or hybridization temperature.

As noted, the Tₘ of any nucleic acid duplex can be directly measured, using techniques well known in the art. For example, a thermal denaturation curve can be obtained for the duplex, the midpoint of which corresponds to the Tₘ. It will be evident that such denaturation curves can be obtained under conditions having essentially any relevant pH, salt concentration, solvent content, and/or the like.

The Tₘ for a particular duplex (e.g., an approximate Tₘ) can also be calculated. For example, the Tₘ for an oligonucleotide-target duplex can be estimated using the following algorithm, which incorporates nearest neighbor thermodynamic parameters:

Tm (Kelvin)=ΔH°/(ΔS°+R ln Cₜ), where the changes in standard enthalpy (ΔH°) and entropy (ΔS°) are calculated from nearest neighbor thermodynamic parameters (see, e.g., SantaLucia (1998) “A unified view of polymer, dumbbell, and oligonucleotide DNA nearest-neighbor thermodynamics” Proc. Natl. Acad. Sci. USA 95:1460-1465, Sugimoto et al. (1996) “Improved thermodynamic parameters and helix initiation factor to predict stability of DNA duplexes” Nucleic Acids Research 24: 4501-4505, Sugimoto et al. (1995) “Thermodynamic parameters to predict stability of RNA/DNA hybrid duplexes” Biochemistry 34:11211-11216, and et al. (1998) “Thermodynamic parameters for an expanded nearest-neighbor model for formation of RNA duplexes with Watson-Crick base pairs” Biochemistry 37: 14719-14735), R is the ideal gas constant (1.987 cal·K⁻¹mole⁻¹), and Cₜ is the molar concentration of the oligonucleotide. The calculated Tₘ is optionally corrected for salt concentration, e.g., Na⁺ concentration, using the formula 1/Tₘ(Na⁺)=1/Tₘ(1M)+(4.29f (G·C)−3.95)×10⁻⁵ ln[Na⁺]+9.40×10⁻⁶ ln²[Na⁺]. See, e.g., Owczarzy et al. (2004) “Effects of sodium ions on DNA duplex oligomers: Improved predictions of melting temperatures” Biochemistry 43:3537-3554 for further details. A web calculator for estimating Tm using the above algorithms is available on the internet at scitools.idtdna.com/analyzer/oligocalc.asp. Other algorithms for calculating Tm are known in the art and are optionally applied to the present invention.

For a given nucleic acid of interest, the corresponding target capture probes are preferably complementary to physically distinct, nonoverlapping sequences in the nucleic acid of interest, which are preferably, but not necessarily, contiguous. The Tₘs of the individual target capture probe-nucleic acid complexes are preferably greater than the hybridization temperature, e.g., by 5° C. or 10° C. or preferably by 15° C. or more, such that these complexes are stable at the hybridization temperature. Sequence U-3 for each target capture probe is typically (but not necessarily) about 17-35 nucleotides in length, with about 30-70% GC content. Potential target capture probe sequences (e.g., potential sequences U-3) are optionally examined for possible interactions with non-corresponding nucleic acids of interest, repetitive sequences (such as polyC or polyT, for example), any detection probes used to detect the nucleic acids of interest, and/or any relevant genomic sequences, for example; sequences expected to cross-hybridize with undesired nucleic acids are typically not selected for use in the target support capture probes. Examination can be, e.g., visual (e.g., visual examination for complementarity), computational (e.g., computation and comparison of percent sequence identity and/or binding free energies; for example, sequence comparisons can be performed using BLAST software publicly available through the National Center for Biotechnology Information on the world wide web at ncbi.nlm.nih.gov), and/or experimental (e.g., cross-hybridization experiments). Support capture probe sequences are preferably similarly examined, to ensure that the polynucleotide sequence U-1 complementary to a particular support capture probe's sequence U-2 is not expected to cross-hybridize with any of the other support capture probes that are to be associated with other subsets of particles.

In one class of embodiments, contacting the sample, the pooled population of particles, and the subsets of n target capture probes comprises combining the sample with the subsets of n target capture probes to form a mixture, and then combining the mixture with the pooled population of particles. In this class of embodiments, the target capture probes typically hybridize first to the corresponding nucleic acid of interest and then to the corresponding particle-associated support capture probe. The hybridizations can, however, occur simultaneously or even in the opposite order. Thus, in another exemplary class of embodiments, contacting the sample, the pooled population of particles, and the subsets of n target capture probes comprises combining the sample, the subsets of target capture probes, and the pooled population of particles.

As noted, the nucleic acids are optionally detected, amplified, isolated, sequenced and/or the like after capture. Thus, in one aspect, a plurality of the particles in each subset are distinguishable from a plurality of the particles in every other subset, and the methods include determining which subsets of particles have a nucleic acid of interest captured on the particles, thereby indicating which of the nucleic acids of interest were present in the sample. For example, in one class of embodiments, each of the nucleic acids of interest comprises a label (including, e.g., one or two or more labels per molecule), and determining which subsets of particles have a nucleic acid of interest captured on the particles comprises detecting a signal from the label. At least a portion of the particles from each subset can be identified and the presence or absence of the label detected on those particles. Since a correlation exists between a particular subset of particles and a particular nucleic acid of interest, which subsets of particles have the label present indicates which of the nucleic acids of interest were present in the sample. In one class of embodiments, the label is covalently associated with the nucleic acid. For example, a fluorescent label can be incorporated into the nucleic acid using a chemical or enzymatic labeling technique. In other embodiments, the nucleic acid is configured to bind the label; for example, a biotinylated nucleic acid can bind a streptavidin-associated label.

The label can be essentially any convenient label that directly or indirectly provides a detectable signal. In one aspect, the label is a fluorescent label (e.g., a fluorophore or quantum dot, e.g., Cy3 or Cy5). Detecting the presence of the label on the particles thus comprises detecting a fluorescent signal from the label. Fluorescent emission by the label is typically distinguishable from any fluorescent emission by the particles, e.g., microspheres, and many suitable fluorescent label-fluorescent microsphere combinations are possible. As other examples, the label can be a luminescent label, a light-scattering label (e.g., colloidal gold particles), or an enzyme (e.g., HRP).

The methods can optionally be used to quantitate the amounts of the nucleic acids of interest present in the sample. For example, in one class of embodiments, an intensity of the signal from the label is measured, e.g., for each subset of particles, and correlated with a quantity of the corresponding nucleic acid of interest present.

As another example, in one class of embodiments, at least one detection probe (a polynucleotide comprising a label or configured to bind a label) is provided for each nucleic acid of interest and hybridized to any nucleic acid of interest captured on the particles. As described above, determining which subsets of particles have a nucleic acid of interest captured on the particles then comprises detecting a signal from the label (e.g., a fluorescent label).

As yet another example, in one class of embodiments, determining which subsets of particles have a nucleic acid of interest captured on the particles comprises amplifying any nucleic acid of interest captured on the particles. A wide variety of techniques for amplifying nucleic acids are known in the art, including, but not limited to, PCR (polymerase chain reaction), rolling circle amplification, and transcription mediated amplification. (See, e.g., Hatch et al. (1999) “Rolling circle amplification of DNA immobilized on solid surfaces and its application to multiplex mutation detection” Genet Anal. 15:35-40; Baner et al. (1998) “Signal amplification of padlock probes by rolling circle replication” Nucleic Acids Res. 26:5073-8; and Nallur et al. (2001) “Signal amplification by rolling circle amplification on DNA microarrays” Nucleic Acids Res. 29:E118.) A labeled primer and/or labeled nucleotides are optionally incorporated during amplification. In other embodiments, the nucleic acids of interest captured on the particles are detected and/or amplified without identifying the subsets of particles and/or the nucleic acids (e.g., in embodiments in which the subsets of particles are not distinguishable).

In one class of embodiments, one or more subsets of particles is isolated, whereby any nucleic acid of interest captured on the particles is isolated. The isolated nucleic acid can optionally be removed from the particles and/or subjected to further manipulation, if desired (e.g., amplification by PCR or the like). The particles from various subsets can be distinguishable or indistinguishable. Further post-capture options are described below.

At any of various steps, materials not captured on the particles are optionally separated from the particles. For example, after the target capture probes, nucleic acids, and particle-bound support capture probes are hybridized, the particles are optionally washed to remove unbound nucleic acids and target capture probes.

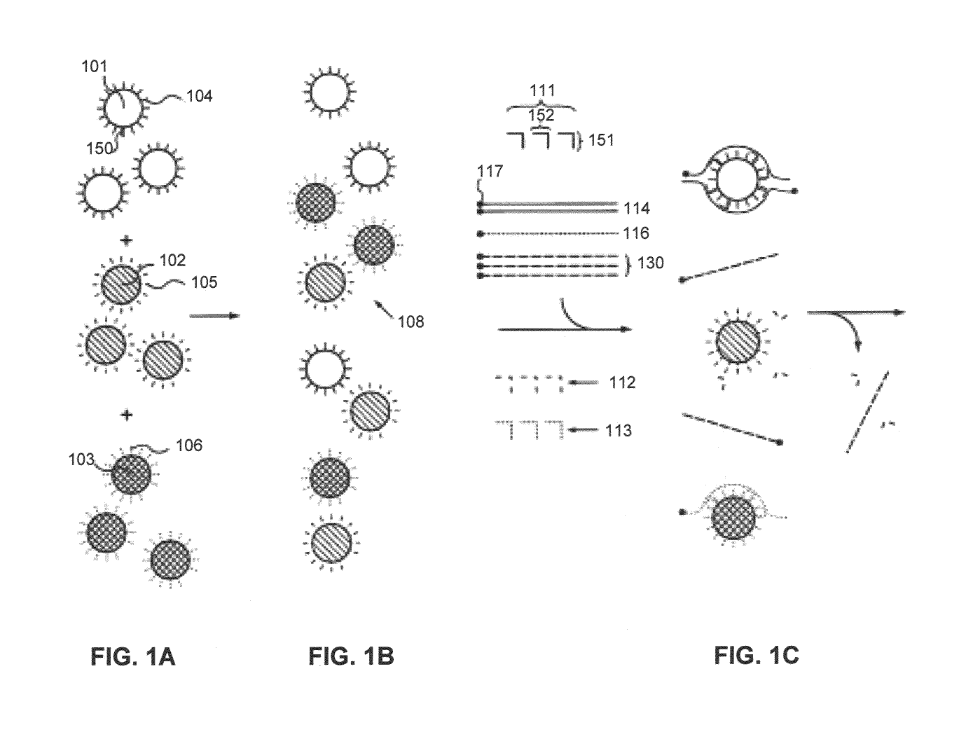

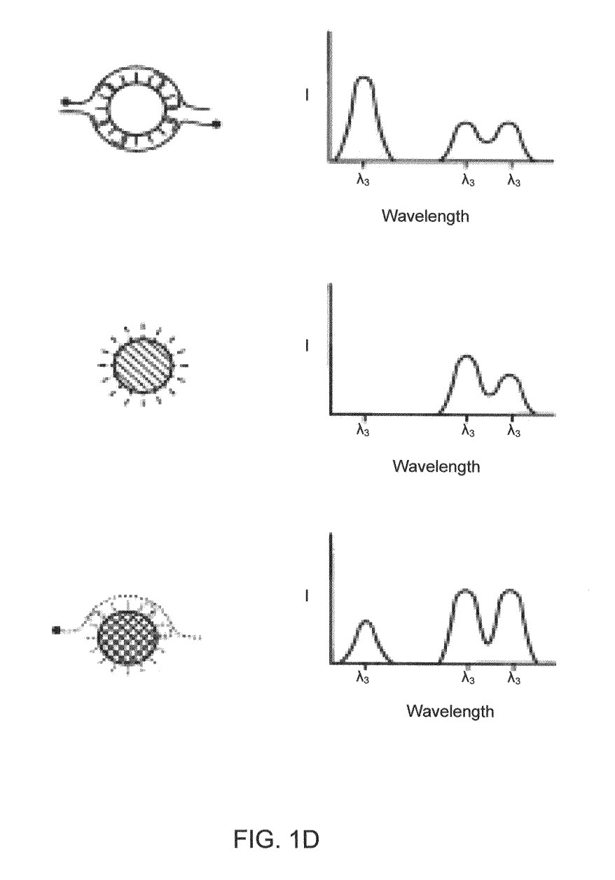

An exemplary embodiment is schematically illustrated in FIG. 1. Panel A illustrates three distinguishable subsets of microspheres 101, 102, and 103, which have associated therewith support capture probes 104, 105, and 106, respectively. Each support capture probe includes a sequence U-2 (150), which is different from subset to subset of microspheres. The three subsets of microspheres are combined to form pooled population 108 (Panel B). A subset of three target capture probes is provided for each nucleic acid of interest; subset 111 for nucleic acid 114, subset 112 for nucleic acid 115 which is not present, and subset 113 for nucleic acid 116. Each target capture probe includes sequences U-1 (151, complementary to the respective support capture probe's sequence U-2) and U-3 (152, complementary to a sequence in the corresponding nucleic acid of interest). Each nucleic acid of interest includes at least one label 117. Non-target nucleic acids 130 are also present in the sample of nucleic acids.

Nucleic acids 114 and 116 are hybridized to their corresponding subset of target capture probes (111 and 113, respectively), and the target capture probes are hybridized to the corresponding support capture probes (104 and 106, respectively), capturing nucleic acids 114 and 116 on microspheres 101 and 103, respectively (Panel C). Materials not captured on the microspheres (e.g., target capture probes 112, nucleic acids 130, etc.) are optionally separated from the microspheres by washing. Microspheres from each subset are identified, e.g., by their fluorescent emission spectrum (λ₂ and λ₃, Panel D), and the presence or absence of the label on each subset of microspheres is detected (λ₁, Panel D). Since each nucleic acid of interest is associated with a distinct subset of microspheres, the presence of the label on a given subset of microspheres correlates with the presence of the corresponding nucleic acid in the original sample.

As depicted in FIG. 1, each support capture probe typically includes a single sequence U-2 and thus hybridizes to a single target capture probe. Optionally, however, a support capture probe can include two or more sequences U-2 and hybridize to two or more target capture probes. Similarly, as depicted, each of the target capture probes in a particular subset typically includes an identical sequence U-1, and thus only a single support capture probe is needed for each subset of particles; however, different target capture probes within a subset optionally include different sequences U-1 (and thus hybridize to different sequences U-2, within a single support capture probe or different support capture probes on the surface of the corresponding subset of particles).

The methods can be used to capture the nucleic acids of interest from essentially any type of sample. For example, the sample can be derived from an animal, a human, a plant, a cultured cell, a virus, a bacterium, a pathogen, and/or a microorganism. The sample optionally includes a cell lysate, e.g. whole blood lysate, an intercellular fluid, a bodily fluid (including, but not limited to, blood, serum, saliva, urine, sputum, or spinal fluid), and/or a conditioned culture medium, and is optionally derived from a tissue (e.g., a tissue homogenate), a biopsy, and/or a tumor. Similarly, the nucleic acids can be essentially any desired nucleic acids. As just a few examples, the nucleic acids of interest can be derived from one or more of an animal, a human, a plant, a cultured cell, a microorganism, a virus, a bacterium, or a pathogen. As additional examples, the two or more nucleic acids of interest can comprise two or more mRNAs, bacterial and/or viral genomic RNAs and/or DNAs (double-stranded or single-stranded), plasmid or other extra-genomic DNAs, or other nucleic acids derived from microorganisms (pathogenic or otherwise). The nucleic acids can be purified, partially purified, or unpurified. The nucleic acids are optionally, but not necessarily, produced by an amplification reaction (e.g., the nucleic acids can be the products of reverse transcription or PCR). It will be evident that double-stranded nucleic acids of interest will typically be denatured before hybridization with target capture probes.

Due to cooperative hybridization of multiple target capture probes to a nucleic acid of interest, for example, even nucleic acids present at low concentration can be captured. Thus, in one class of embodiments, at least one of the nucleic acids of interest is present in the sample in a non-zero amount of 200 attomole (amol) or less, 150 amol or less, 100 amol or less, 50 amol or less, 10 amol or less, 1 amol or less, or even 0.1 amol or less, 0.01 amol or less, 0.001 amol or less, or 0.0001 amol or less. Similarly, two nucleic acids of interest can be captured simultaneously, even when they differ in concentration by 1000-fold or more in the sample. The methods are thus extremely versatile.

Capture of a particular nucleic acid is optionally quantitative. Thus, in one exemplary class of embodiments, the sample includes a first nucleic acid of interest, and at least 30%, at least 50%, at least 80%, at least 90%, at least 95%, or even at least 99% of a total amount of the first nucleic acid present in the sample is captured on a first subset of particles. Second, third, etc. nucleic acids can similarly be quantitatively captured. Such quantitative capture can occur without capture of a significant amount of undesired nucleic acids, even those of very similar sequence to the nucleic acid of interest.

Thus, in one class of embodiments, the sample comprises or is suspected of comprising a first nucleic acid of interest and a second nucleic acid which has a polynucleotide sequence which is 95% or more identical to that of the first nucleic acid (e.g., 96% or more, 97% or more, 98% or more, or even 99% or more identical). The first nucleic acid, if present in the sample, is captured on a first subset of particles, while the second nucleic acid comprises 1% or less of a total amount of nucleic acid captured on the first subset of particles (e.g., 0.5% or less, 0.2% or less, or even 0.1% or less). The second nucleic acid can be another nucleic acid of interest or simply any nucleic acid. Typically, target capture probes are chosen that hybridize to regions of the first nucleic acid having the greatest sequence difference from the second nucleic acid.

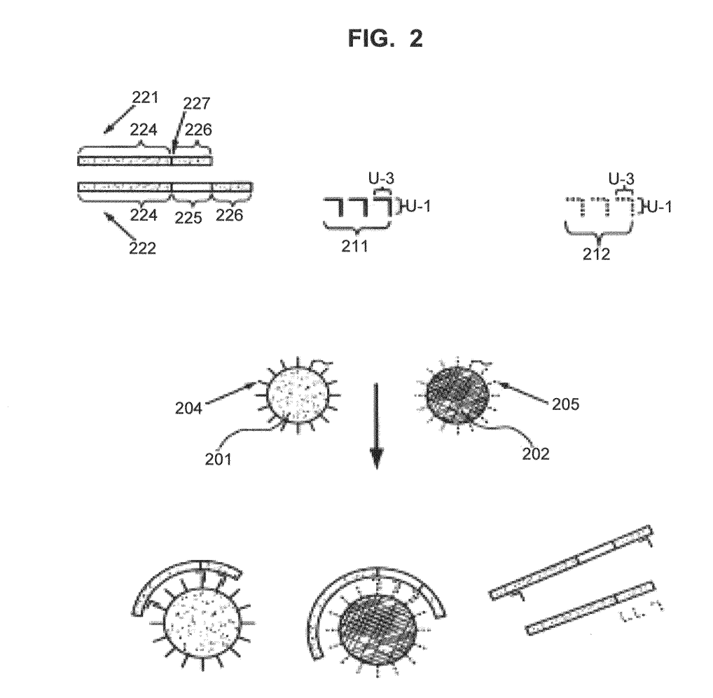

As just one example of how closely related nucleic acids can be differentially captured using the methods of the invention, different splice variants of a given mRNA can be selectively captured. Thus, in one class of embodiments, the sample comprises a first nucleic acid of interest and a second nucleic acid, where the first nucleic acid is a first splice variant and the second nucleic acid is a second splice variant of the given mRNA. A first subset of n target capture probes is capable of hybridizing to the first splice variant, of which at most n−1 target capture probes are capable of hybridizing to the second splice variant. Optionally, at least 80% or more, 90% or more, or 95% or more of the first splice variant is captured on a first subset of particles while at most 10% or less, 5% or less, 3% or less, or 1% or less of the second splice variant is captured on the first subset of particles. Preferably, hybridization of the n target capture probes to the first splice variant captures the first splice variant on a first subset of particles while hybridization of the at most n−1 target capture probes to the second splice variant does not capture the second splice variant on the first subset of particles. An exemplary embodiment illustrating capture of two splice variants is schematically depicted in FIG. 2. In this example, three target capture probes 211 hybridize to first splice variant 221, one to each exon (224 and 226) and one to splice junction 227 (the only sequence found in first splice variant 221 and not also found in second splice variant 222); two of these bind to second splice variant 222. Similarly, three target capture probes 212 bind to second splice variant 222, one to intron 225 and one to each of the splice junctions; none of these bind to first splice variant 221. Through cooperative hybridization of the target capture probes to the splice variants and to the corresponding support capture probes (204 and 205), splice variants 221 and 222 are each captured specifically only on the corresponding subset of microspheres (201 and 202, respectively). Optionally, for any nucleic acid, hybridization of a first subset of n target capture probes to a first nucleic acid captures the first nucleic acid on a first subset of particles while hybridization of at most n−1 of the target capture probes to a second nucleic acid does not capture the second nucleic acid on the first subset of particles.

It will be evident that nucleic acids that do not have 100% identical sequences are alternatively optionally captured on the same subset of particles, if desired. For example, a first and a second nucleic acid are optionally both captured on a first subset of particles, through binding of the same or different subsets of target capture probes. The first and second nucleic acids can be closely related; for example, splice variants of a particular mRNA, different alleles of a gene, somatic mutations, homologs, or the like. Similarly, it will be evident that a single type of particle bearing a single support capture probe (rather than multiple distinguishable subsets of particles bearing different support capture probes) can be used to capture multiple nucleic acids, e.g., in aspects in which a few specific target nucleic acids are to be isolated and/or in which individual targets need not be identified.

A support capture probe and/or target capture probe optionally comprises at least one non-natural nucleotide. For example, a support capture probe and the corresponding target capture probe optionally comprise, at complementary positions, at least one pair of non-natural nucleotides that base pair with each other but that do not Watson-Crick base pair with the bases typical to biological DNA or RNA (i.e., A, C, G, T, or U). Examples of nonnatural nucleotides include, but are not limited to, Locked NucleicAcid™ nucleotides (available from Exiqon A/S, on the world wide web at (www.) exiqon.com; see, e.g., SantaLucia Jr. (1998) Proc Natl Acad Sci 95:1460-1465) and isoG, isoC, and other nucleotides used in the AEGIS system (Artificially Expanded Genetic Information System, available from EraGen Biosciences, (www.) eragen.com; see, e.g., U.S. Pat. Nos. 6,001,983, 6,037,120, and 6,140,496). Use of such non-natural base pairs (e.g., isoG-isoC base pairs) in the support capture probes and target capture probes can, for example, decrease cross hybridization, or it can permit use of shorter support capture probe and target capture probes when the non-natural base pairs have higher binding affinities than do natural base pairs.

The preceding embodiments include capture of the nucleic acids of interest on particles. Alternatively, the nucleic acids can be captured at different positions on a non-particulate, spatially addressable solid support. Accordingly, another general class of embodiments includes methods of capturing two or more nucleic acids of interest. In the methods, a sample, a solid support, and two or more subsets of n target capture probes, wherein n is at least two, are provided. The sample comprises or is suspected of comprising the nucleic acids of interest. The solid support comprises two or more support capture probes, each of which is provided at a selected position on the solid support. Each subset of n target capture probes is capable of hybridizing to one of the nucleic acids of interest, and the target capture probes in each subset are capable of hybridizing to one of the support capture probes and thereby associating each subset of n target capture probes with a selected position on the solid support. Each nucleic acid of interest can thus, by hybridizing to its corresponding subset of n target capture probes which are in turn hybridized to a corresponding support capture probe, be associated with, e.g., a known, predetermined location on the solid support. The sample, the solid support, and the subsets of n target capture probes are contacted, any nucleic acid of interest present in the sample is hybridized to its corresponding subset of n target capture probes, and the subset of n target capture probes is hybridized to its corresponding support capture probe. The hybridizing the nucleic acid of interest to the n target capture probes and the n target capture probes to the corresponding support capture probe captures the nucleic acid on the solid support at the selected position with which the target capture probes are associated.

The hybridizing the subset of n target capture probes to the corresponding support capture probe is typically performed at a hybridization temperature which is greater than a melting temperature Tₘ of a complex between each individual target capture probe and its corresponding support capture probe. For example, the hybridization temperature can be about 5° C. or more greater than the Tₘ, e.g., about 7° C. or more, about 10° C. or more, about 12° C. or more, about 15° C. or more, about 17° C. or more, or even about 20° C. or more greater than the Tₘ.

The methods are useful for multiplex capture of nucleic acids, optionally highly multiplex capture. Thus, the two or more nucleic acids of interest (i.e., the nucleic acids to be captured) optionally comprise five or more, 10 or more, 20 or more, 30 or more, 40 or more, 50 or more, 100 or more, 10³ or more, or 10⁴ or more nucleic acids of interest. A like number of selected positions on the solid support and subsets of target capture probes are provided; thus, the two or more selected positions can comprise five or more, 10 or more, 20 or more, 30 or more, 40 or more, 50 or more, 100 or more, 10³ or more, or 10⁴ or more selected positions, while the two or more subsets of n target capture probes can comprise five or more, 10 or more, 20 or more, 30 or more, 40 or more, 50 or more, 100 or more, 10³ or more, or 10⁴ or more subsets of n target capture probes.

The solid support typically has a planar surface and is typically rigid, but essentially any spatially addressable solid support can be adapted to the practice of the present invention. Exemplary materials for the solid support include, but are not limited to, glass, silicon, silica, quartz, plastic, polystyrene, nylon, and nitrocellulose. As just one example, an array of support capture probes can be formed at selected positions on a glass slide as the solid support.

As for the embodiments described above, the nucleic acids are optionally detected, amplified, isolated, and/or the like after capture. Thus, in one aspect, the methods include determining which positions on the solid support have a nucleic acid of interest captured at that position, thereby indicating which of the nucleic acids of interest were present in the sample. For example, in one class of embodiments, each of the nucleic acids of interest comprises a label (including, e.g., one or two or more labels per molecule), and determining which positions on the solid support have a nucleic acid of interest captured at that position comprises detecting a signal from the label, e.g., at each position. Since a correlation exists between a particular position on the support and a particular nucleic acid of interest, which positions have a label present indicates which of the nucleic acids of interest were present in the sample. In one class of embodiments, the label is covalently associated with the nucleic acid. In other embodiments, the nucleic acid is configured to bind the label; for example, a biotinylated nucleic acid can bind a streptavidin-associated label.

The methods can optionally be used to quantitate the amounts of the nucleic acids of interest present in the sample. For example, in one class of embodiments, an intensity of the signal from the label is measured, e.g., for each of the selected positions, and correlated with a quantity of the corresponding nucleic acid of interest present.

As another example, in one class of embodiments, at least one detection probe (a polynucleotide comprising a label or configured to bind a label) is provided for each nucleic acid of interest and hybridized to any nucleic acid of interest captured on the support. As described above, determining which positions on the support have a nucleic acid of interest captured on the support then comprises detecting a signal from the label. As yet another example, in one class of embodiments, determining which positions on the solid support have a nucleic acid of interest captured at that position comprises amplifying any nucleic acid of interest captured on the solid support, as for the embodiments described above.

At any of various steps, materials not captured on the solid support are optionally separated from the solid support. For example, after the target capture probes, nucleic acids, and support-bound support capture probes are hybridized, the solid support is optionally washed to remove unbound nucleic acids and target capture probes.

Essentially all of the features noted for the methods above apply to these embodiments as well, as relevant; for example, with respect to number of target capture probes per subset, configuration of the target capture probes and/or support capture probes, label configuration, source of the sample and/or nucleic acids, and/or the like.

For example, in one class of embodiments, contacting the sample, the solid support, and the subsets of n target capture probes comprises combining the sample with the subsets of n target capture probes to form a mixture, and then contacting the mixture with the solid support. In this class of embodiments, the target capture probes typically hybridize first to the corresponding nucleic acid of interest and then to the corresponding particle-associated support capture probe. In other embodiments, however, the hybridizations can occur simultaneously or even in the opposite order.

As for the embodiments described above, capture of a particular nucleic acid is optionally quantitative. Thus, in one exemplary class of embodiments, the sample includes a first nucleic acid of interest, and at least 30%, at least 50%, at least 80%, at least 90%, at least 95%, or even at least 99% of a total amount of the first nucleic acid present in the sample is captured at a first selected position on the solid support. Second, third, etc. nucleic acids can similarly be quantitatively captured. Such quantitative capture can occur without capture of a significant amount of undesired nucleic acids, even those of very similar sequence to the nucleic acid of interest.

Thus, in one class of embodiments, the sample comprises or is suspected of comprising a first nucleic acid of interest and a second nucleic acid which has a polynucleotide sequence which is 95% or more identical to that of the first nucleic acid (e.g., 96% or more, 97% or more, 98% or more, or even 99% or more identical). The first nucleic acid, if present in the sample, is captured at a first selected position on the solid support, while the second nucleic acid comprises 1% or less of a total amount of nucleic acid captured at the first position (e.g., 0.5% or less, 0.2% or less, or even 0.1% or less). The second nucleic acid can be another nucleic acid of interest or simply any nucleic acid. Typically, target capture probes are chosen that hybridize to regions of the first nucleic acid having the greatest sequence difference from the second nucleic acid.

As just one example of how closely related nucleic acids can be differentially captured using the methods of the invention, different splice variants of a given mRNA can be selectively captured. Thus, in one class of embodiments, the sample comprises a first nucleic acid of interest and a second nucleic acid, where the first nucleic acid is a first splice variant and the second nucleic acid is a second splice variant of the given mRNA. A first subset of n target capture probes is capable of hybridizing to the first splice variant, of which at most n−1 target capture probes are capable of hybridizing to the second splice variant. Optionally, at least 80% or more, 90% or more, or 95% or more of the first splice variant is captured at a first selected position on the solid support while at most 10% or less, 5% or less, 3% or less, or 1% or less of the second splice variant is captured at the first position. Preferably, hybridization of the n target capture probes to the first splice variant captures the first splice variant at a first selected position on the solid support while hybridization of the at most n−1 target capture probes to the second splice variant does not capture the second splice variant at the first position.

It will be evident that nucleic acids that do not have 100% identical sequences are alternatively optionally captured at the same position of the support, if desired. For example, a first and a second nucleic acid are optionally both captured at a first position, through binding of the same or different subsets of target capture probes. The first and second nucleic acids can be closely related; for example, splice variants of a particular mRNA, different alleles of a gene, somatic mutations, homologs, or the like. Similarly, it will be evident that a single support-bound support capture probe (rather than different support capture probes at different selected positions on the support) can be used to capture multiple nucleic acids, e.g., in aspects in which a few specific target nucleic acids are to be isolated and/or in which individual targets need not be identified.

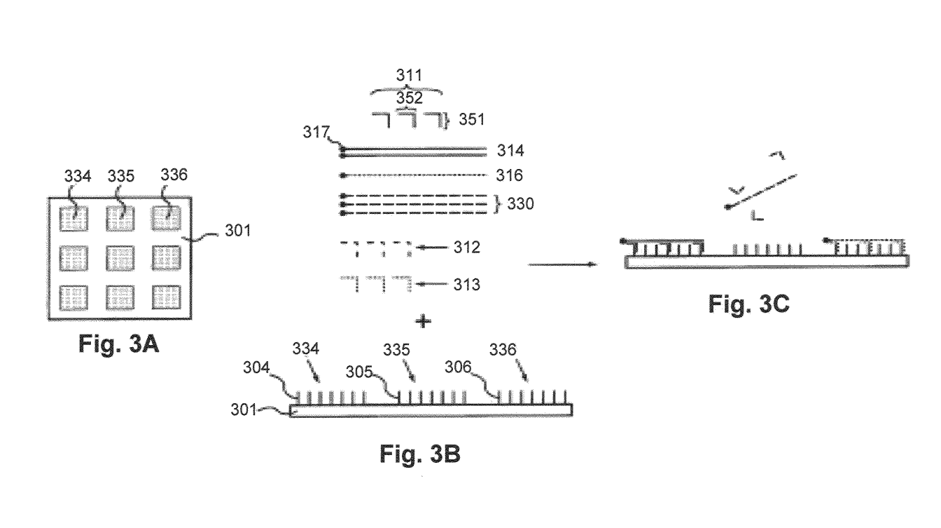

An exemplary embodiment is schematically illustrated in FIG. 3. Panel A depicts solid support 301 having nine support capture probes provided on it at nine selected positions (e.g., 334-336). Panel B depicts a cross section of solid support 301, with distinct support capture probes 304, 305, and 306 at different selected positions on the support (334, 335, and 336, respectively). A subset of target capture probes is provided for each nucleic acid of interest. Only three subsets are depicted; subset 311 for nucleic acid 314, subset 312 for nucleic acid 315 which is not present, and subset 313 for nucleic acid 316. Each target capture probe includes sequences U-1 (351, complementary to the respective support capture probe's sequence U-2) and U-3 (352, complementary to a sequence in the corresponding nucleic acid of interest). Each nucleic acid of interest includes at least one label 317. Non-target nucleic acids 330 are also present in the sample of nucleic acids.

Nucleic acids 314 and 316 are hybridized to their corresponding subset of target capture probes (311 and 313, respectively), and the target capture probes are hybridized to the corresponding support capture probes (304 and 306, respectively), capturing nucleic acids 314 and 316 at selected positions 334 and 336, respectively (Panel C). Materials not captured on the solid support (e.g., target capture probes 312, nucleic acids 330, etc.) are optionally removed by washing the support, and the presence or absence of the label at each position on the solid support is detected. Since each nucleic acid of interest is associated with a distinct position on the support, the presence of the label at a given position on the support correlates with the presence of the corresponding nucleic acid in the original sample.

The methods of the present invention offer a number of advantages. For example, a single array of support capture probes at selected positions on a solid support can be manufactured, and this single array can be used to capture essentially any desired group of nucleic acids of interest simply by synthesizing appropriate subsets of target capture probes. A new array need not be manufactured for each new group of nucleic acids to be captured, unlike conventional microarray technologies in which arrays of target-specific probes attached to a solid support are utilized, necessitating the manufacture of a new array for each new group of target nucleic acids to be captured and detected. Similarly, a single population of subsets of particles comprising support capture probes can be manufactured and used for capture of essentially any desired group of nucleic acids of interest. As previously noted, capture of a nucleic acid of interest through multiple, individually relatively weak hybridization events can provide greater specificity than does capturing the nucleic acid through hybridization with a single oligonucleotide. It can also provide greater ability to discriminate between closely related sequences than does capturing the nucleic acid through hybridization with a cDNA or other large probe.

In another embodiment of the present invention, the target nucleic acid of interest may be about 10 kilobases (kB) in length. Alternatively, the target nucleic acid may be any number of kB in length between 10-40 kB, or even 45 kB or 50 kB in length or more. The target may be in the range of 40-75 kB in length. The target nucleic acid of interest may be as long as 100 kB in length. In this embodiment, the regions that the target capture probes are complementary to in the target nucleic acid may be separated by an insubstantial or a significant length of nucleic acid sequence. This difference in length may be known or unknown. As a non-limiting example of such an embodiment, two or more target capture probes may have sequences complementary to a 40 kB length target nucleic acid. The two or more target capture probes may be complementary to the target nucleic acid at regions that lie on the very 5′ end and at the very 3′ end of the target nucleic acid, with as many as 39.5 kB or more nucleic acid between the two or more target capture probe hybridization locations. Target capture probes may be designed to hybridize to the target nucleic acid at any position along the entire length of the target nucleic acid.

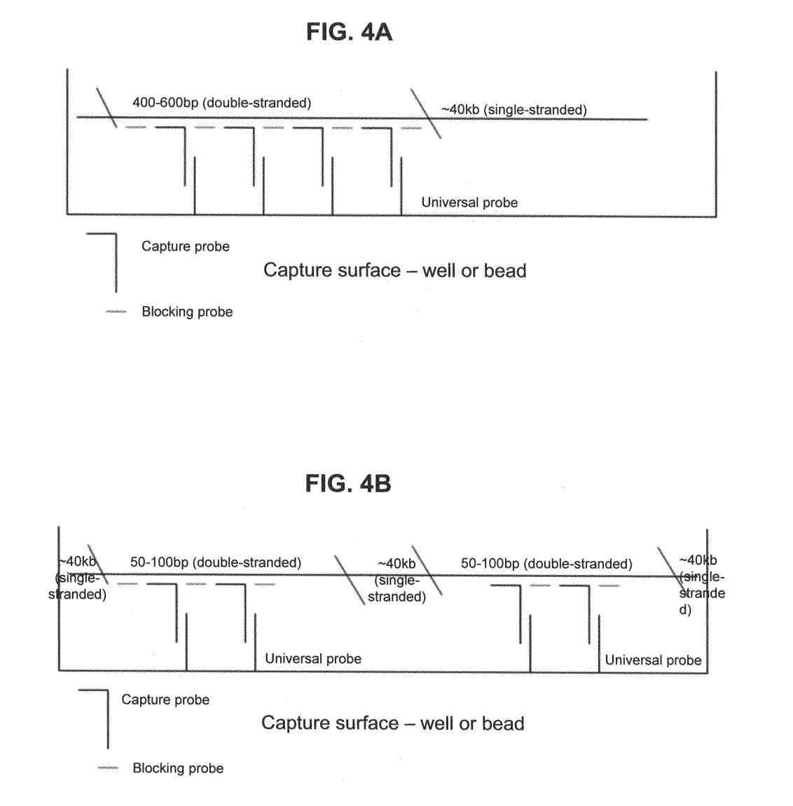

In some embodiments, the method of the presently claimed invention is designed to determine the sequence of the target nucleic acid that lies between the two ends of the target nucleic acid that are hybridized to the target capture probes. Thus, there may be a first set of one or more target capture probes hybridized in a nonoverlapping manner at the very 5′ end of the target nucleic acid, and a second set of one or more target capture probes hybridized in a nonoverlapping manner at the very 3′ end of the target nucleic acid, or any location on the target nucleic acid. For instance, see FIG. 4. In FIG. 4, Panel A, both subsets of target capture probes are hybridized to the same end of the target nucleic acid. On the other hand, for instance in FIG. 4, Panel B, different sets of nonoverlapping target capture probes may be designed to hybridize to opposite ends of the target nucleic acid.

FIGS. 4-7 depict a class of embodiments wherein the target capture probes hybridize to support capture probes which are bound to a solid support. That is, the support may be a solid support which is not a particle, microsphere, microparticle, or spatially addressable support. The support may be, for instance, the bottom of an assay well. Laboratory products are available which hold various numbers of wells in solid support form, such as a 1536-well plate, 384-well plate, 96-well plate, 24-well plate, 12-well plate, 6-well plate, or carrying any number of wells therebetween. The solid support may be comprised of any known material which is compatible with nucleotide assays, such as plastic. Plastics, and mixtures thereof, of many different varieties are known to be compatible with nucleotide assays. Often these plastics may be coated or further prepared/blocked prior to exposure to nucleotides. The support capture probes may be bound to the wells or substrates by any number of means known in the art, such as covalent bonding, and the like. The wells of the solid support may be of a size that is suitable for conducting the presented methods of the invention. For instance, the solid support can be arranged in a “dip stick” format wherein a solid support/substrate stick is inserted into the lysate or sample contained in a vessel or well. The support can also be a bead, which is loaded into column, in a manner similar to those used in affinity chromatography. In the bead-column approach, a large sample volume containing the sample/lysate and probes can flow through and around the beads which contain the support capture probes. This may help to facilitate capturing of minute amounts of target diluted in a large sample size.

The method of the invention may be conducted such that a plurality of different target nucleic acids are bound in each well. That is, in each well, a multiplex assay may be run such that each well is designed to capture multiple targets. The targets may be between 1-10, or as many as 20, or 30 or even 50, as previously discussed.

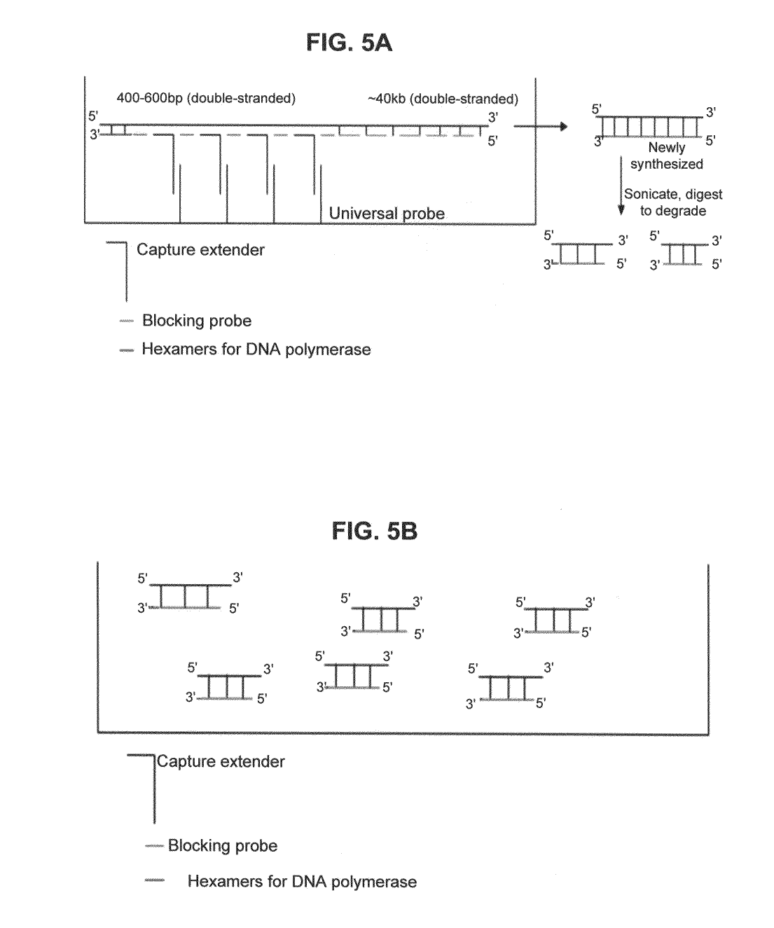

In another class of embodiments, where double stranded target nucleic acid is desired, the method may further include hybridization of random primers to the target nucleic acid after, or simultaneously with, the hybridization of the target nucleic acid to the target capture probes and/or support capture probes, as shown in, for instance, FIG. 5A. The random primers serve as starting points for DNA synthesis by one or more types of DNA polymerases. The random primers may be designed to bind to the regions of the target nucleic acid where target capture probes are not bound. For instance, in the above class of non-limiting embodiments, where there is a significant stretch of unknown sequence in the target nucleic acid between the two sets of target capture probes, the random primers could hybridize thereto to create randomly positioned double-stranded (ds) regions of target nucleic acid. (See, for instance, Wong et al., Nucl. Acids Res., 24:3778-3783, 1996, incorporated herein by reference). The random primers may be of any suitable length. For instance, random primers are known to be useful in hexamer length, 7-mer length, 8-mer length, or 9-13-mer and the like.

Upon hybridization of the random primers to the target nucleic acid, polymerase enzymes may be used to generate a complete double-stranded copy of the target nucleic acid corresponding to the regions where the random primers hybridized, as depicted in FIGS. 5A and 5B. Polymerase enzymes are known in the art which possess strand displacement activity, and others which do not possess strand displacement activity. Non-strand-displacing polymerases, used in this embodiment, would leave various “nicks” in the double-stranded target nucleic acid.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

In the above embodiment, the long stretches of target nucleic acid which have been converted to double-stranded nucleic acid may be further cleaved or digested into smaller fragments of double-stranded nucleic acid (see FIG. 5A). For instance, by sonication, partial digestion with nuclease treatment using Mung Bean nuclease or S1 nuclease for example, DNase I treatment, restriction enzyme using HaeIII for instance, or other enzymatic and non-enzymatic methods, e.g. chemical methods, the double-stranded target nucleic acid may be broke into smaller segments having a length of, for instance 50 base pairs (bp) or more. (See, for instance, Elsner et al., “Ultrasonic Degradation of DNA,” DNA, 8(10):697-701, 1989, incorporated herein by reference). Alternatively, the double-stranded target nucleic acids may be broken down into 50-60 bp lengths, or 50-60 bp lengths, or 60-70 bp lengths, or 70-100 bp lengths, or 100-200 bp lengths, or 200-300 bp lengths, or 300-400 bp lengths, or 400-500 bp lengths, or any mixture of lengths lying between these ranges, such that the target double-stranded nucleic acid may be directly used in later nucleic acid sequencing methodologies. Chemical methods of digestion of DNA include, for instance UV-directed cleavage of DNA (both single stranded and double stranded, chemical cleavage using copper and prodigiosin (see, for instance, Melvin et al., J. Am. Chem. Soc., 122(26):6333-6334, 2000), chemical cleavage by manganese tris(methylpyridiniumyl)porphyrin linked to spermine olihonucleotides (see, Pitie et al., J. Biol. Inorg. Chem., 1(3):239-246, 1996), use of single-base mismatches and potassium permanganate or hydroxylamine (see, Neschastnova, et al., Mol. Biol., 41(3):477-484, 2007), hydroxyl radicals, and the like as known in the art. (All references cited herein incorporated by reference for all purposes in their entirety).

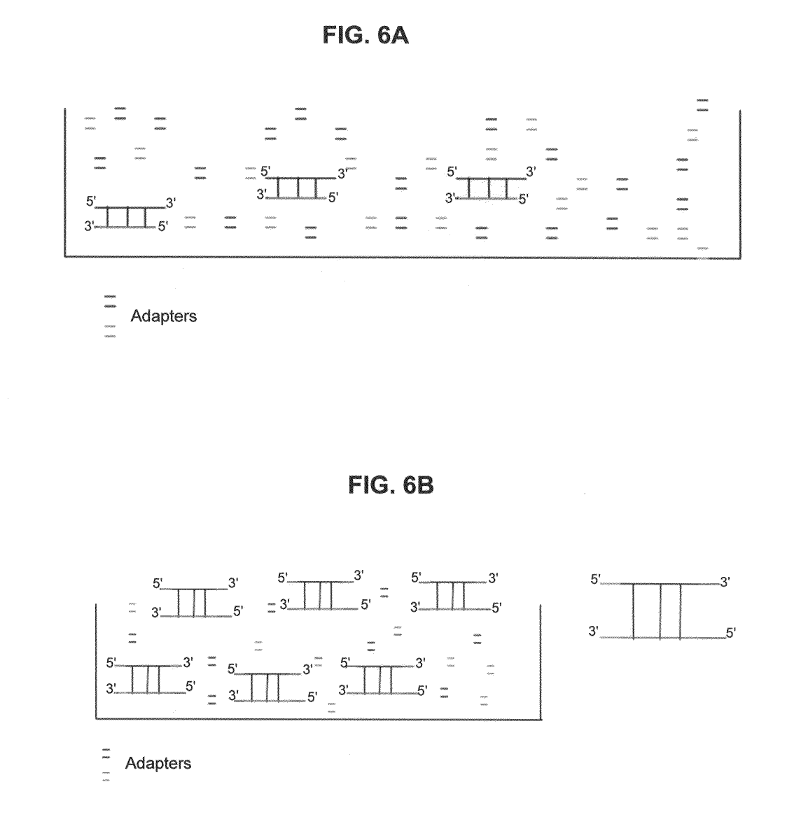

In the above embodiment, the method may optionally further include ligation of asymmetric adapters, which may also be double stranded, by enzymes known to be capable of such ligation, as depicted in FIGS. 6A and 6B. Ligation may be performed on blunt-ended double-stranded target nucleic acid. Ligation may be performed using various known means, such as use of T4 DNA ligase, and the like. The target double-stranded nucleic acid may be additionally prepared prior to ligation by forming blunt ends, using any number of known procedures for such tasks, such as, for instance, the use of DNA polymerase I, (Klenow) fragment or T4 DNA polymerase, and the like. Furthermore, to prevent ligation of asymmetric adapters to non-target nucleic acids, e.g. probes, the probes may comprise modified ends, such as dideoxynucleotide and amide ends or o-methyl groups at the 3 prime and 5 prime ends to preclude ligation by T4 DNA ligase.

The order in which the above-described steps may be performed may be manipulated to suit the desired need depending on the type of sample being enriched. Additionally, the presently described methods may be applied to whole genome amplification DNA samples, or genomic DNA samples, cleavage of the sample into smaller fragments and ligation of the double stranded asymmetric adapters may be performed before capturing the target nucleic acids of interest onto the target capture probes, support capture probes and/or substrate, and the like. After capturing the desired target nucleic acids, the enriched sample may be optionally washed, denatured from the target capture probes, and then used directly for standard or next generation-type sequencing protocols.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

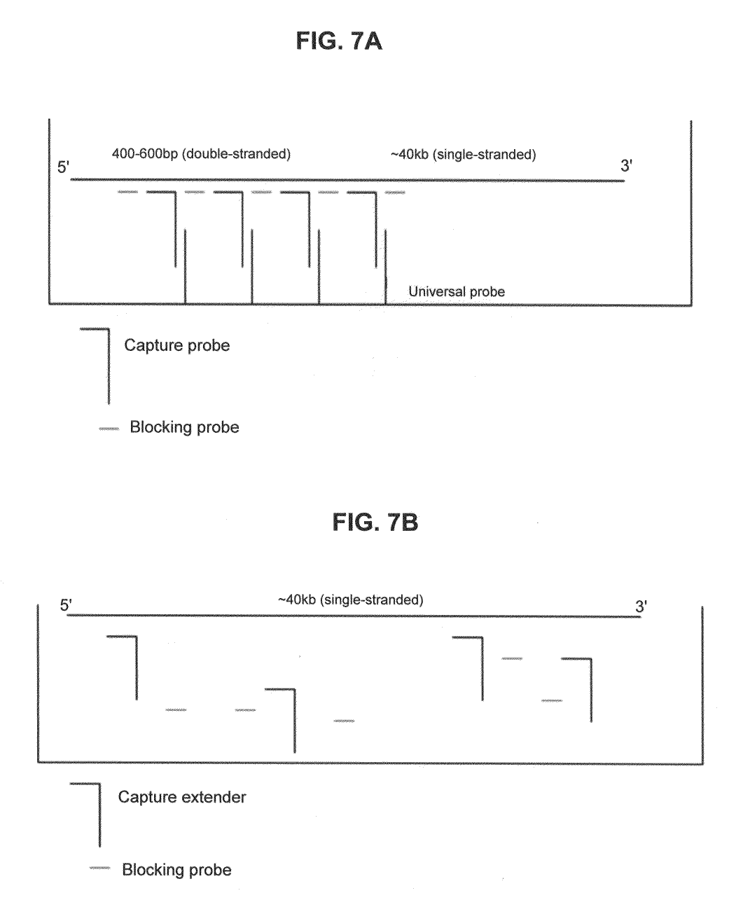

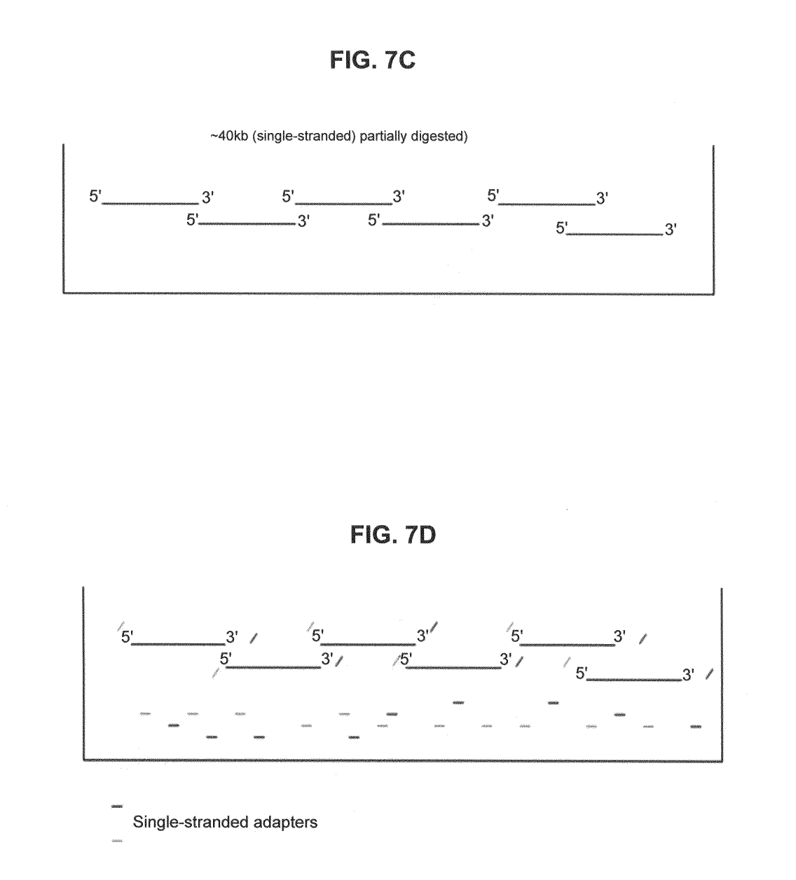

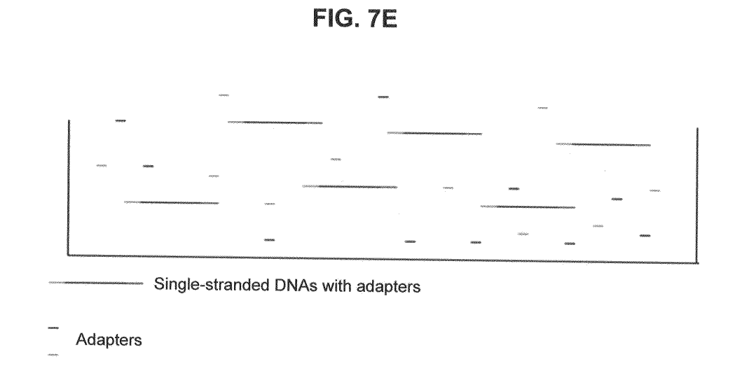

Various known sequencing methodologies may be employed using the generated purified target nucleic acids generated utilizing the above embodiments and methods. Furthermore, to prevent generation of target double-stranded nucleic acid sequences corresponding to known sequences located between target capture probe hybridization sites, optional blocking probes may be included in the reactions precluding formation of double-stranded target nucleic acid fragments corresponding to those regions. Use of blocking probes, if desired, is also depicted in FIGS. 4 and 7.

In a further embodiment, the probes, e.g. target capture probes, blocking probes, and/or support capture probes, may be made of ribonucleic acid. In this class of embodiments, the probes may then be selectively degraded and thereby removed from later reactions by RNase or other known non-enzymatic means of selectively degrading RNA in a mixture of RNA and DNA. (See, for instance, Kuimelis, Robert G., Chem. Rev., 98(3):1027-1044, 1998, incorporated herein by reference in its entirety for all purposes). Conversely, if the target nucleic acid is RNA, for instance perhaps it may be mRNA, then the probes may alternatively be comprised of DNA and a selective agent applied to eliminate the DNA probes from the RNA targets capture and purified. Other optional permutations of the present method may call for transcription of mRNA into cDNA prior to, or after, performing the capture step of the present methods. Modified nucleic acids may additionally be employed to achieve differentiated digestion of non-target nucleic acids. For instance, use may be made of PNA, morpholino nucleic acids, constrained-ethyl nucleic acids, LNA, and the like. These modified nucleic acids would be resistant to digestion with DNase I or other nucleases and restriction enzymes. (See, for instance, Nielsen et al., Nucl. Acids Res., 21(2):197-200, 1993, incorporated herein by reference in its entirety for all purposes). Additionally, RNA target nucleic acids may be directly sequenced by known methods. (See, Peattie, Debra A., Proc. Natl. Acad. Sci. USA, 76(4):1760-1764, 1979, incorporated herein by reference in its entirety for all purposes).

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

In another class of embodiments, the random primers may include therein adapters, such that later treatments to create blunt ends and ligate adapters are not necessary. Further, the random primers may not be random at all. That is, primers with or without adapter sequences may be designed for regions of the target nucleic acid for which sequence information is already known. Later creation of double-stranded DNA may then be started in the known regions and proceed to unknown regions. Further manipulations as described above can then be used to generate double-stranded target nucleic acids of desired length and possessing adapters for use in downstream sequencing methodologies.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

Additionally, the invention discloses embodiments that do not require the generation of double-stranded target nucleic acid, as shown in FIG. 7, Panels A-E. Instead, single-stranded target nucleic acids are isolated from the sample using the present methods, and then optionally broken into single-stranded target nucleic acids of desired length and adapters ligated thereto. It is known that T4 RNA ligase, and other ligases, are capable of ligating small adapter sequences to single-stranded nucleic acids. (See, Zhang et al., Nuc. Acids Res., 24(5):990-991, 1996, and Edwards et al. (1991) Nucleic Acids Res., 19:5227-5232, and Tessier et al., (1986) Anal. Biochem., 158, 171-178, all of which are incorporated herein by reference). However, this ligation may be somewhat inefficient and amplification of the target prior to ligation, by PCR or any other similar amplification procedure, may be helpful in increasing the efficiency and outcome of the ligation reaction. Ligation of asymmetric adapters to the single stranded target nucleic acid may be achieved by utilizing adaptors which possess a 5 prime phosphate group. Generation of 5 prime phosphate groups is routine in the art and may be achieved by treatment with T4 polynucleotide kinase enzyme. These single-stranded target nucleic acids, optionally possessing adapters, may also then be used in further downstream sequencing methodologies designed to determine the nucleic acid sequence of the target nucleic acid in the unknown regions lying between the target capture probe hybridization sites.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, type of particles, label configuration, source of the sample and/or nucleic acids, and/or the like.

### Compositions

Compositions related to the methods are another feature of the invention. Thus, one general class of embodiments provides a composition that includes two or more subsets of particles and two or more subsets of n target capture probes, wherein n is at least two. The particles in each subset have associated therewith a different support capture probe. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. When the nucleic acid of interest corresponding to a subset of n target capture probes is present in the composition and is hybridized to the subset of n target capture probes, which are hybridized to the corresponding support capture probe, the nucleic acid of interest is hybridized to the subset of n target capture probes at a hybridization temperature which is greater than a melting temperature Tₘ of a complex between each individual target capture probe and the support capture probe.

In one preferred class of embodiments, a plurality of the particles in each subset are distinguishable from a plurality of the particles in every other subset. Typically, substantially all of the particles in each subset are distinguishable from substantially all of the particles in every other subset. Alternatively, the particles comprising the various subsets are not distinguishable.

The composition optionally includes a sample comprising or suspected of comprising at least one of the nucleic acids of interest, e.g., two or more, three or more, etc. nucleic acids. In one class of embodiments, the composition comprises one or more of the nucleic acids of interest. Each nucleic acid of interest is hybridized to its corresponding subset of n target capture probes, and the corresponding subset of n target capture probes is hybridized to its corresponding support capture probe. Each nucleic acid of interest is thus associated with a subset of the particles. The composition is maintained at the hybridization temperature.

As noted, the hybridization temperature is greater than the Tₘ of each of the individual target capture probe-support capture probe complexes. The hybridization temperature is typically about 5° C. or more greater than the Tₘ, e.g., about 7° C. or more, about 10° C. or more, about 12° C. or more, about 15° C. or more, about 17° C. or more, or even about 20° C. or more greater than the Tₘ.

Essentially all of the features noted for the methods above apply to these embodiments as well, as relevant; for example, with respect to number of target capture probes per subset, configuration of the target capture probes and/or support capture probes, number of nucleic acids of interest and of subsets of particles and target capture probes, type of particles, source of the sample and/or nucleic acids, and/or the like.

As noted, even nucleic acids present at low concentration can be captured. Thus, in one class of embodiments, at least one of the nucleic acids of interest is present in the composition in a non-zero amount of 200 amol or less, 150 amol or less, 100 amol or less, 50 amol or less, 10 amol or less, 1 amol or less, or even 0.1 amol or less, 0.01 amol or less, 0.001 amol or less, or 0.0001 amol or less. Similarly, two nucleic acids of interest can be captured simultaneously, even when they differ in concentration by 1000-fold or more in the composition.

Capture of a particular nucleic acid on the particles is optionally quantitative. Thus, in one exemplary class of embodiments, the composition includes a first nucleic acid of interest, and at least 30%, at least 50%, at least 80%, at least 90%, at least 95%, or even at least 99% of a total amount of the first nucleic acid present in the composition is captured on a first subset of particles. Second, third, etc. nucleic acids can similarly be quantitatively captured. Such quantitative capture can occur without capture of a significant amount of undesired nucleic acids, even those of very similar sequence to the nucleic acid of interest.

Thus, in one class of embodiments, the composition comprises or is suspected of comprising a first nucleic acid of interest and a second nucleic acid which has a polynucleotide sequence which is 95% or more identical to that of the first nucleic acid (e.g., 96% or more, 97% or more, 98% or more, or even 99% or more identical). The first nucleic acid, if present in the composition, is captured on a first subset of particles, while the second nucleic acid comprises 1% or less of a total amount of nucleic acid captured on the first subset of particles (e.g., 0.5% or less, 0.2% or less, or even 0.1% or less). The second nucleic acid can be another nucleic acid of interest or simply any nucleic acid. Typically, target capture probes are chosen that hybridize to regions of the first nucleic acid having the greatest sequence difference from the second nucleic acid.

In one exemplary class of embodiments in which related nucleic acids are differentially captured, the composition comprises a first nucleic acid of interest and a second nucleic acid, where the first nucleic acid is a first splice variant and the second nucleic acid is a second splice variant of a given mRNA. A first subset of n target capture probes is capable of hybridizing to the first splice variant, of which at most n−1 target capture probes are capable of hybridizing to the second splice variant. Optionally, at least 80% or more, 90% or more, or 95% or more of the first splice variant is captured on a first subset of particles while at most 10% or less, 5% or less, 3% or less, or 1% or less of the second splice variant is captured on the first subset of particles. Preferably, a first subset of n target capture probes is hybridized to the first splice variant, whereby the first splice variant is captured on a first subset of particles, and at most n−1 of the target capture probes are hybridized to the second splice variant, whereby the second splice variant is not captured on the first subset of particles.

In one class of embodiments, the composition includes one or more of the nucleic acids of interest, each of which includes a label or is configured to bind to a label. The composition optionally includes one or more of: a cell lysate, an intercellular fluid, a bodily fluid, a conditioned culture medium, a polynucleotide complementary to a nucleic acid of interest and comprising a label, or a reagent used to amplify nucleic acids (e.g., a DNA polymerase, an oligonucleotide primer, or nucleoside triphosphates).

A related general class of embodiments provides a composition comprising two or more subsets of particles, two or more subsets of n target capture probes, wherein n is at least two, and at least a first nucleic acid of interest. The particles in each subset have associated therewith a different support capture probe. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. In this class of embodiments, the composition is maintained at a hybridization temperature, which hybridization temperature is greater than a melting temperature Tₘ of a complex between each individual target capture probe and its corresponding support capture probe. The first nucleic acid of interest is hybridized to a first subset of n first target capture probes, which first target capture probes are hybridized to a first support capture probe.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, use of labeled nucleic acids of interest, additional components of the composition, source of the sample and/or nucleic acids, and/or the like. Optionally, a plurality of the particles in each subset are distinguishable from a plurality of the particles in every other subset. (Typically, substantially all of the particles in each subset are distinguishable from substantially all of the particles in every other subset.)

Another general class of embodiments provides a composition that includes a solid support comprising two or more support capture probes, each of which is provided at a selected position on the solid support, and two or more subsets of n target capture probes, wherein n is at least two. Each subset of n target capture probes is capable of hybridizing to one of the nucleic acids of interest, and the target capture probes in each subset are capable of hybridizing to one of the support capture probes and thereby associating each subset of n target capture probes with a selected position on the solid support. Optionally, the solid support may be provided in a multi-well format which does not have spatially addressable locations for the support capture probes. As discussed above, the solid support may be supplied as a plate of wells having any number of wells, made out of a suitable material and of a suitable size.

The composition optionally includes a sample comprising or suspected of comprising at least one of the nucleic acids of interest, e.g., two or more, three or more, etc. nucleic acids. In one class of embodiments, the composition includes at least a first nucleic acid of interest and is maintained at a hybridization temperature. The first nucleic acid of interest is hybridized to a first subset of n first target capture probes, which first target capture probes are hybridized to a first support capture probe; the first nucleic acid is thereby associated with a first selected position on the solid support. It will be evident that the composition optionally includes second, third, etc. nucleic acids of interest, which are likewise associated with second, third, etc. selected positions on the solid support through association with second, third, etc. subsets of target capture probes and second, third, etc. support capture probes. The hybridization temperature is greater than a melting temperature Tₘ of a complex between each individual target capture probe and its corresponding support capture probe. The hybridization temperature is typically about 5° C. or more greater than the Tₘ, e.g., about 7° C. or more, about 10° C. or more, about 12° C. or more, about 15° C. or more, about 17° C. or more, or even about 20° C. or more greater than the Tₘ.

Essentially all of the features noted for the embodiments above apply to these embodiments as well, as relevant; for example, with respect to number of target capture probes per subset, type of solid support, configuration of the target capture probes and/or support capture probes, number of nucleic acids of interest and of selected positions on the solid support and subsets of target capture probes, use of labeled nucleic acids of interest, additional components of the composition, source of the sample and/or nucleic acids, and/or the like.

### Kits

Yet another general class of embodiments provides a kit for capturing two or more nucleic acids of interest. The kit includes two or more subsets of particles and two or more subsets of n target capture probes, wherein n is at least two, packaged in one or more containers. The particles in each subset have associated therewith a different support capture probe. Each subset of n target capture probes is capable of hybridizing to one of the nucleic acids of interest, and the target capture probes in each subset are capable of hybridizing to one of the support capture probes and thereby associating each subset of n target capture probes with a selected subset of the particles. When the nucleic acid of interest corresponding to a subset of n target capture probes is hybridized to the subset of n target capture probes, which are hybridized to the corresponding support capture probe, the nucleic acid of interest is hybridized to the subset of n target capture probes at a hybridization temperature which is greater than a melting temperature Tₘ of a complex between each individual target capture probe and the support capture probe. The kit optionally also includes instructions for using the kit to capture and optionally detect the nucleic acids of interest, one or more buffered solutions (e.g., lysis buffer, diluent, hybridization buffer, and/or wash buffer), standards comprising one or more nucleic acids at known concentration, and/or the like.

Essentially all of the features noted for the embodiments above apply to these embodiments as well, as relevant; for example, with respect to number of target capture probes per subset, configuration of the target capture probes and/or support capture probes, number of nucleic acids of interest and of subsets of particles and target capture probes, source of the sample and/or nucleic acids, type of particles, and/or the like. Preferably, a plurality of the particles in each subset are distinguishable from a plurality of the particles in every other subset. (Typically, substantially all of the particles in each subset are distinguishable from substantially all of the particles in every other subset.)

A related general class of embodiments provides a kit for capturing two or more nucleic acids of interest. The kit includes a solid support comprising two or more support capture probes, each of which is provided at a selected position on the solid support, and two or more subsets of n target capture probes, wherein n is at least two, packaged in one or more containers. Each subset of n target capture probes is capable of hybridizing to one of the nucleic acids of interest, and the target capture probes in each subset are capable of hybridizing to one of the support capture probes and thereby associating each subset of n target capture probes with a selected position on the solid support. The kit may also optionally contain blocking probes, random primers, adapters, and various enzymes needed to conduct sequencing of the target nucleic acid downstream of the capturing step. Further, the substrate provided may or may not be pre-bound with support capture probes to allow the end-user more flexibility in designing experiments.

In one class of embodiments, when a nucleic acid of interest corresponding to a subset of n target capture probes is hybridized to the subset of n target capture probes, which are hybridized to the corresponding support capture probe, the nucleic acid of interest is hybridized to the subset of n target capture probes at a hybridization temperature which is greater than a melting temperature Tₘ of a complex between each individual target capture probe and the support capture probe. The hybridization temperature is typically about 5° C. or more greater than the Tₘ, e.g., about 7° C. or more, about 10° C. or more, about 12° C. or more, about 15° C. or more, about 17° C. or more, or even about 20° C. or more greater than the Tₘ.

The kit optionally also includes instructions for using the kit to capture and optionally detect the nucleic acids of interest, one or more buffered solutions (e.g., lysis buffer, diluent, hybridization buffer, and/or wash buffer), standards comprising one or more nucleic acids at known concentration, and/or the like. The kit may also optionally comprise enzymes, such as polymerases, nucleases, restriction enzymes, ligases, and the like, useful in performing downstream sequencing reactions or other downstream methods useful with the present kits.

Essentially all of the features noted for the embodiments above apply to these embodiments as well, as relevant; for example, with respect to number of target capture probes per subset, configuration of the target capture probes and/or support capture probes, number of nucleic acids of interest and of selected positions on the solid support and subsets of target capture probes, type of support, source of the sample and/or nucleic acids, and/or the like.\

### Labels

A wide variety of labels are well known in the art and can be adapted to the practice of the present invention. For example, luminescent labels and light-scattering labels (e.g., colloidal gold particles) have been described. See, e.g., Csaki et al. (2002) “Gold nanoparticles as novel label for DNA diagnostics” Expert Rev Mol Diagn 2:187-93.

As another example, a number of fluorescent labels are well known in the art, including but not limited to, hydrophobic fluorophores (e.g., phycoerythrin, rhodamine, Alexa Fluor 488 and fluorescein), green fluorescent protein (GFP) and variants thereof (e.g., cyan fluorescent protein and yellow fluorescent protein), and quantum dots. See e.g., Haughland (2003) Handbook of Fluorescent Probes and Research Products, Ninth Edition or Web Edition, from Molecular Probes, Inc., or The Handbook: A Guide to Fluorescent Probes and Labeling Technologies, Tenth Edition or Web Edition (2006) from Invitrogen (available on the world wide web at probes.invitrogen.com/handbook) for descriptions of fluorophores emitting at various different wavelengths (including tandem conjugates of fluorophores that can facilitate simultaneous excitation and detection of multiple labeled species). For use of quantum dots as labels for biomolecules, see e.g., Dubertret et al. (2002) Science 298:1759; Nature Biotechnology (2003) 21:41-46; and Nature Biotechnology (2003) 21:47-51.

Labels can be introduced to molecules, e.g. polynucleotides, during synthesis or by postsynthetic reactions by techniques established in the art; for example, kits for fluorescently labeling polynucleotides with various fluorophores are available from Molecular Probes, Inc. ((www.) molecularprobes.com), and fluorophore-containing phosphoramidites for use in nucleic acid synthesis are commercially available, as are fluorophore-containing nucleotides (e.g., Cy3 or Cy5 labeled dCTP, dUTP, dTTP, and the like). Similarly, signals from the labels (e.g., absorption by and/or fluorescent emission from a fluorescent label) can be detected by essentially any method known in the art. For example, multicolor detection, detection of FRET, fluorescence polarization, and the like, are well known in the art.

### Microspheres

Microspheres are preferred particles in certain embodiments described herein since they are generally stable, are widely available in a range of materials, surface chemistries and uniform sizes, and can be fluorescently dyed. Microspheres can optionally be distinguished from each other by identifying characteristics such as their size (diameter) and/or their fluorescent emission spectra, for example.

Luminex Corporation ((www.) luminexcorp.com), for example, offers 100 sets of uniform diameter polystyrene microspheres. The microspheres of each set are internally labeled with a distinct ratio of two fluorophores. A flow cytometer or other suitable instrument can thus be used to classify each individual microsphere according to its predefined fluorescent emission ratio. Fluorescently-coded microsphere sets are also available from a number of other suppliers, including Radix Biosolutions ((www.) radixbiosolutions.com) and Upstate Biotechnology ((www.) upstatebiotech.com). Alternatively, BD Biosciences ((www.) bd.com) and Bangs Laboratories, Inc. ((www.) bangslabs.com) offer microsphere sets distinguishable by a combination of fluorescence and size. Other companies, such as Duke Scientific Corp. (now a subsidiary of Thermo Scientific Int'l. Inc.) and Microgenics Corp. (Fremont, Calif., now a subsidiary of Thermo Scientific, Inc.), provides products referred to as Cyto-Plex, Carboxylated Microspheres which also are useful in the present assays and methods. As another example, microspheres can be distinguished on the basis of size alone, but fewer sets of such microspheres can be multiplexed in an assay because aggregates of smaller microspheres can be difficult to distinguish from larger microspheres.

Microspheres with a variety of surface chemistries are commercially available, from the above suppliers and others (e.g., see additional suppliers listed in Kellar and Iannone (2002) “Multiplexed microsphere-based flow cytometric assays” Experimental Hematology 30:1227-1237 and Fitzgerald (2001) “Assays by the score” The Scientist 15[11]:25). For example, microspheres with carboxyl, hydrazide or maleimide groups are available and permit covalent coupling of molecules (e.g., polynucleotide support capture probes with free amine, carboxyl, aldehyde, sulfhydryl or other reactive groups) to the microspheres. As another example, microspheres with surface avidin or streptavidin are available and can bind biotinylated support capture probes; similarly, microspheres coated with biotin are available for binding support capture probes conjugated to avidin or streptavidin. In addition, services that couple a capture reagent of the customer's choice to microspheres are commercially available, e.g., from Radix Biosolutions ((www.) radixbiosolutions.com).

Protocols for using such commercially available microspheres (e.g., methods of covalently coupling polynucleotides to carboxylated microspheres for use as support capture probes, methods of blocking reactive sites on the microsphere surface that are not occupied by the polynucleotides, methods of binding biotinylated polynucleotides to avidin-functionalized microspheres, and the like) are typically supplied with the microspheres and are readily utilized and/or adapted by one of skill. In addition, coupling of reagents to microspheres is well described in the literature. For example, see Yang et al. (2001) “BADGE, Beads Array for the Detection of Gene Expression, a high-throughput diagnostic bioassay” Genome Res. 11:1888-98; Fulton et al. (1997) “Advanced multiplexed analysis with the FlowMetrix™ system” Clinical Chemistry 43:1749-1756; Jones et al. (2002) “Multiplex assay for detection of strain-specific antibodies against the two variable regions of the G protein of respiratory syncytial virus” 9:633-638; Camilla et al. (2001) “Flow cytometric microsphere-based immunoassay: Analysis of secreted cytokines in whole-blood samples from asthmatics” Clinical and Diagnostic Laboratory Immunology 8:776-784; Martins (2002) “Development of internal controls for the Luminex instrument as part of a multiplexed seven-analyte viral respiratory antibody profile” Clinical and Diagnostic Laboratory Immunology 9:41-45; Kellar and Iannone (2002) “Multiplexed microsphere-based flow cytometric assays” Experimental Hematology 30:1227-1237; Oliver et al. (1998) “Multiplexed analysis of human cytokines by use of the FlowMetrix system” Clinical Chemistry 44:2057-2060; Gordon and McDade (1997) “Multiplexed quantification of human IgG, IgA, and IgM with the FlowMetrix™ system” Clinical Chemistry 43:1799-1801; U.S. Pat. No. 5,981,180 entitled “Multiplexed analysis of clinical specimens apparatus and methods” to Chandler et al. (Nov. 9, 1999); U.S. Pat. No. 6,449,562 entitled “Multiplexed analysis of clinical specimens apparatus and methods” to Chandler et al. (Sep. 10, 2002); and references therein.

Methods of analyzing microsphere populations (e.g. methods of identifying microsphere subsets by their size and/or fluorescence characteristics, methods of using size to distinguish microsphere aggregates from single uniformly sized microspheres and eliminate aggregates from the analysis, methods of detecting the presence or absence of a fluorescent label on the microsphere subset, and the like) are also well described in the literature. See, e.g., the above references.

Suitable instruments, software, and the like for analyzing microsphere populations to distinguish subsets of microspheres and to detect the presence or absence of a label (e.g., a fluorescently labeled nucleic acid) on each subset are commercially available. For example, flow cytometers are widely available, e.g., from Becton-Dickinson ((www.) bd.com) and Beckman Coulter ((www.) beckman.com). Luminex 100™ and Luminex HTS™ systems (which use microfluidics to align the microspheres and two lasers to excite the microspheres and the label) are available from Luminex Corporation ((www.) luminexcorp.com); the similar Bio-Plex™ Protein Array System is available from Bio-Rad Laboratories, Inc. ((www.) bio-rad.com). A confocal microplate reader suitable for microsphere analysis, the FMAT™ System 8100, is available from Applied Biosystems ((www.) appliedbiosystems.com).

As another example of particles that can be adapted for use in the present invention, sets of microbeads that include optical barcodes are available from CyVera Corporation ((www.) cyvera.com). The optical barcodes are holographically inscribed digital codes that diffract a laser beam incident on the particles, producing an optical signature unique for each set of microbeads.

### Molecular Biological Techniques

In practicing the present invention, many conventional techniques in molecular biology, microbiology, and recombinant DNA technology are optionally used. These techniques are well known and are explained in, for example, Berger and Kimmel, Guide to Molecular Cloning Techniques, Methods in Enzymology volume 152 Academic Press, Inc., San Diego, Calif.; Sambrook et al., Molecular Cloning—A Laboratory Manual (3rd Ed.), Vol. 1-3, Cold Spring Harbor Laboratory, Cold Spring Harbor, N.Y., 2000 and Current Protocols in Molecular Biology, F. M. Ausubel et al., eds., Current Protocols, a joint venture between Greene Publishing Associates, Inc. and John Wiley & Sons, Inc., (supplemented through 2006). Other useful references, e.g. for cell isolation and culture (e.g., for subsequent nucleic acid or protein isolation) include Freshney (1994) Culture of Animal Cells, a Manual of Basic Technique, third edition, Wiley-Liss, New York and the references cited therein; Payne et al. (1992) Plant Cell and Tissue Culture in Liquid Systems John Wiley & Sons, Inc. New York, N.Y.; Gamborg and Phillips (Eds.) (1995) Plant Cell, Tissue and Organ Culture; Fundamental Methods Springer Lab Manual, Springer-Verlag (Berlin Heidelberg New York) and Atlas and Parks (Eds.) The Handbook of Microbiological Media (1993) CRC Press, Boca Raton, Fla.

### Polynucleotides and Nucleic Acids

Methods of making nucleic acids (e.g., by in vitro amplification, purification from cells, or chemical synthesis), methods for manipulating nucleic acids (e.g., by restriction enzyme digestion, ligation, etc.) and various vectors, cell lines and the like useful in manipulating and making nucleic acids are described in the above references.

In addition, essentially any polynucleotide (including, e.g., labeled or biotinylated polynucleotides) can be custom or standard ordered from any of a variety of commercial sources, such as The Midland Certified Reagent Company ((www.) mcrc.com), The Great American Gene Company ((www.) genco.com), ExpressGen Inc. ((www.) expressgen.com), Qiagen (oligos.qiagen.com) and many others.

A label, biotin, or other moiety can optionally be introduced to a polynucleotide, either during or after synthesis. For example, a biotin phosphoramidite can be incorporated during chemical synthesis of a polynucleotide. Alternatively, any nucleic acid can be biotinylated using techniques known in the art; suitable reagents are commercially available, e.g., from Pierce Biotechnology ((www.) piercenet.com). Similarly, any nucleic acid can be fluorescently labeled, for example, by using commercially available kits such as those from Molecular Probes, Inc. ((www.) molecularprobes.com) or Pierce Biotechnology ((www.) piercenet.com), by incorporating a fluorescently labeled phosphoramidite during chemical synthesis of a polynucleotide, or by incorporating a fluorescently labeled nucleotide during enzymatic synthesis of a polynucleotide.

While the foregoing invention has been described in some detail for purposes of clarity and understanding, it will be clear to one skilled in the art from a reading of this disclosure that various changes in form and detail can be made without departing from the true scope of the invention. For example, all the techniques and compositions described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A method of capturing two or more nucleic acids of interest, the method comprising:
a) providing a sample comprising or suspected of comprising the nucleic acids of interest;
b) providing a substrate having associated therewith a plurality of support capture probe;
c) providing two or more subsets of n target capture probes, wherein n is at least two, wherein each subset of n target capture probes is capable of hybridizing to one of the nucleic acids of interest, and wherein the target capture probes in each subset are capable of hybridizing to one of the support capture probes and thereby associating each subset of n target capture probes with a selected subset of the particles;
d) contacting the sample, the substrate, and the subsets of n target capture probes; and
e) hybridizing any nucleic acid of interest present in the sample to its corresponding subset of n target capture probes and hybridizing the subset of n target capture probes to its corresponding support capture probe, whereby the hybridizing the nucleic acid of interest to the n target capture probes and the n target capture probes to the corresponding support capture probe captures the nucleic acid on the subset of particles with which the target capture probes are associated,
wherein the hybridizing the subset of n target capture probes to the corresponding support capture probe is performed at a hybridization temperature which is greater than a melting temperature Tₘ of a complex between each individual target capture probe and its corresponding support capture probe.

2. The method according to claim 1, wherein the nucleic acid of interest is at least 10 kB in length.

3. The method according to claim 1, wherein the nucleic acid of interest is at least 1.7 kB in length.

4. The method according to claim 1, wherein the nucleic acid of interest is at least 3.2 kB in length.

5. The method according to claim 3, wherein the two or more subsets of target capture probes comprise a first subset of capture probes comprising a sequence which is complementary to a sequence located within 100 base pairs of the 5 prime end of the nucleic acid of interest, and a second subset of capture probes comprising a sequence which is complementary to a sequence located within 100 base pairs of the 3 prime end of the nucleic acid of interest.

6. The method according to claim 1, wherein the substrate is selected from one or more of the group consisting of: a 1536-well plate, a 384-well plate, a 96-well plate, a 24-well plate, a 12-well plate, and a 6-well plate.

7. The method of claim 1, wherein the two or more nucleic acids of interest comprise five or more, 10 or more, 20 or more, 30 or more, 40 or more, or 50 or more nucleic acids of interest.

8. The method according to claim 1, wherein the substrate is a pooled population of particles, the population comprising two or more subsets of particles, the particles in each subset having associated therewith different support capture probes.

9. The method according to claim 8, wherein the two or more subsets of particles comprise five or more, 10 or more, 20 or more, 30 or more, 40 or more, or 50 or more subsets of particles, and wherein the two or more subsets of n target capture probes comprise five or more, 10 or more, 20 or more, 30 or more, 40 or more, or 50 or more subsets of n target capture probes.

10. The method according to claim 8, wherein the particles are microparticles each comprising one or more barcodes.

11. The method according to claim 1, wherein each target capture probe comprises a polynucleotide sequence U-1 that is complementary to a polynucleotide sequence U-2 in its corresponding support capture probe, and wherein U-1 and U-2 are 20 nucleotides or less in length.

12. The method according to claim 11, wherein U1 and U2 are between 9 and 17 nucleotides in length.

13. The method according to claim 11, wherein U-1 and U-2 are between 12 and 15 nucleotides in length.

14. The method according to claim 1, wherein the hybridization temperature is about 5° C. or more greater than the Tₘ.

15. The method according to claim 14, wherein the hybridization temperature is about 7° C. or more, about 10° C. or more, about 12° C. or more, about 15° C. or more, about 17° C. or more, or about 20° C. or more greater than the Tₘ.

16. The method according to claim 1, further comprising the steps of:
f) contacting the nucleic acids of interest with one or more blocking probes;
g) contacting the nucleic acids of interest with one or more random primers;
i) incubating the nucleic acids of interest with a polymerase and free nucleic acid triphosphates;
j) incubating the nucleic acids of interest with a restriction enzyme;
k) incubating the nucleic acids of interest with a plurality of adapter primers and a ligase; and
l) subjecting the nucleic acids of interest to nucleotide sequencing.

17. A composition comprising:
a substrate having associated therewith a plurality of support capture probes; and
two or more subsets of n target capture probes, wherein n is at least two, wherein each subset of n target capture probes is capable of hybridizing to a different nucleic acid of interest, and wherein the target capture probes in each subset are capable of hybridizing to one of the support capture probes and thereby associating each subset of n target capture probes with the substrate,
wherein when the nucleic acid of interest corresponding to a subset of n target capture probes is present in the composition and is hybridized to the subset of n target capture probes, which target capture probes are hybridized to the corresponding support capture probe, the nucleic acid of interest is hybridized to the subset of n target capture probes at a hybridization temperature which is greater than a melting temperature Tₘ of a complex between each individual target capture probe and the support capture probe.

18. The composition according to claim 17, wherein the substrate comprises two or more subsets of particles, the particles in each subset having associated therewith different support capture probes.

19. The composition according to claim 18, wherein the particles are microparticles comprising barcodes.

20. The composition according to claim 17, further comprising blocking probes, a set of random primers, a polymerase, a ligase, a restriction enzyme and adapter primers suitable for downstream sequencing of the nucleic acid of interest.
